(19) United States
(12) Patent Application Publication
(10) Pub. No.: US 2006/0069726 A1
(43) Pub. Date: Mar. 30, 2006

(54) Hospitality environment communications architecture

(75) Inventors: Michael T. McKibben, Columbus, OH (US); Jeffrey R. Lamb, Westerville, OH (US)

Correspondence Address: ERIC D. JORGENSON, 1457 KING ROAD, HINCKLEY, OH, 44233, US

(73) Assignee: Leader Technologies, Inc., Westerville, OH (US)

(21) Appl. No.: 11/257,491

(22) Filed: Oct. 24, 2005

Related U.S. Application Data
(63) Continuation-in-part of application No. 10/979,611, filed on Nov. 2, 2004.
(63) Continuation-in-part of application No. 10/731,906, filed on Dec. 10, 2003.
Application No. 10/979,611 is a continuation-in-part of application No. 10/732,744, filed on Dec. 10, 2003.
(60) Provisional application No. 60/621,704, filed on Oct. 25, 2004.
(60) Provisional application No. 60/516,307, filed on Nov. 3, 2003.
(60) Provisional application No. 60/432,257, filed on Dec. 11, 2002.
(60) Provisional application No. 60/432,255, filed on Dec. 11, 2002.

(51) Int. Cl. G06F 15/16

(52) U.S. Cl. 709/204

(57) ABSTRACT

A hospitality teleconferencing architecture. A web-supported teleconferencing system interfaces to a hospitality communications system to facilitate teleconferencing capabilities in the hospitality network. The system can include a hospitality communications network component that facilitates hospitality communications, and a web-supported teleconferencing system component that interfaces to the hospitality communications network to facilitate the hospitality communications services. The web-supported teleconferencing system can also communicate via VoIP. The web-supported teleconferencing system facilitates communications to at least one of wired and wireless telephone communications systems and, one-way and two-way communications.

### CROSS-REFERENCE TO RELATED APPLICATIONS

This application claims the benefit of U.S. Provisional Patent Application Ser. No. 60/621,704 entitled “HOSPITALITY TELECONFERENCING SYSTEM AND METHODS” and filed Oct. 25, 2004. This application is also a Continuation-in-Part of U.S. patent application Ser. No. 10/979,611 entitled “COMMUNICATION SYSTEM AND METHOD”, filed Nov. 2, 2004, which claims the benefit of U.S. Provisional Patent Application Ser. No. 60/516,307 entitled “COMMUNICATION SYSTEM AND METHOD” and filed Nov. 3, 2003. The entireties of the above-noted applications are incorporated by reference herein.

### TECHNICAL FIELD

This invention is related to teleconferencing systems, and more specifically, to interfacing such teleconferencing systems to hospitality communication systems.

### BACKGROUND

The advent of global communications networks such as the Internet has facilitated numerous collaborative enterprises. In addition to basic e-mail exchanges and intercommunications, such communications networks offer the capability to provide conferencing arrangements whereby one or many customers can be bridged together on a media conference connection. Individuals and business people seek to communicate with each other, obtain useful information, interact commercially and entertain themselves in an increasingly mobile society. In order to fulfill these needs, one requires the capability to send and receive messages, access information and entertainment content, conduct business transactions, organize daily schedules and generally, stay in touch with homes and offices from almost anywhere, at any time, as easily as making a telephone call.

One method of collaborative communications is via a conference call. A conference call session can utilize a bridge device or system that allows several connection endpoints to be bound together to establish a communications conference session. Communications conferences may include voice, video, data and an assortment of other media streams. Historically, each session participant is contacted at the appropriate time to establish a communication path between a conference call bridge and the participant's customer station. The participant is then informed that he or she is wanted for a conference call and then added to the bridge where the participant can talk with the other participants. This type of an arrangement is under the control and supervision of an operator or attendant who can answer, add, or disconnect individual conferees to the bridge with minimal interference to the other conferees connected.

An improvement over the above is a conference call service, which is offered by a third party to set up a conference call between multiple parties. Such services can require an originator to contact a conference call coordinator with the date and time of the call and the telephone numbers (and names) of the participants. The coordinator initiates the conference at the appropriate time by contacting and connecting the participants. This frees the originator from manually dialing the telephone numbers of the participants, but requires yet another human operator to coordinate the call.

High-end prior art teleconferencing systems can provide a number of conferencing capabilities. However, such systems can be an enormous cost to businesses (e.g., hotels) who desire such options and capabilities. Thus, small businesses are left dealing with legacy systems that have limited teleconferencing capabilities. Moreover, such low-end conventional systems do not provide adequate security as the more costly systems. Despite the proliferation of communication devices and the development of the Internet, significant barriers remain to fulfilling user needs for access to and management of personal, professional and public information.

Accordingly, there exists a need for an improved call management capability system that can provide the advanced features of high cost systems, but for significantly less cost.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, includes a call management architecture. The architecture facilitates call management from the perspective of a hospitality environment and includes a hospitality communications component and a web-supported call communications component. The terms web-supported are intended to include IP-capable for any packet network, as well as capable of being disposed on the Internet, and capable of receiving and processing web services. The architecture finds application in any hospitality environment such as hotels or any other lodging facilities (e.g., resorts, retreats, specialized conference facilities, dormitories, lodges, campgrounds . . . ). The hospitality communications component can comprise a local telephone switching system such as a PABX (private automatic branch exchange) system, and/or a VoIP (voice over IP) that facilitates access to an IP network (e.g., the Internet) for IP packet-based calls thereover. The hospitality communications component interfaces to a web-supported telephone communications component that utilizes IP network services for connecting and routing calls, for example. The architecture supports at least multimedia communications and teleconferencing capabilities to hospitality providers.

In another aspect thereof of the subject innovation, a system is provided that facilitates hospitality teleconferencing communications services. The system can include a hospitality communications network component that facilitates hospitality communications (e.g., telephone system and packet-based network), and a web-supported teleconferencing system component that interfaces to the hospitality communications network to facilitate the hospitality communications services. The web-supported teleconferencing system can also communicate via VoIP. The web-supported teleconferencing system facilitates communications to at least one of wired and wireless telephone communications systems and, one-way and two-way communications.

In another aspect thereof, the web-supported teleconferencing system communicates hospitality services information to a group of users via a single PIN.

In another aspect of the subject invention, the system further comprises an artificial intelligence component that employs a probabilistic and/or statistical-based analysis to prognose or infer an action that a user desires to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a call session system in accordance with the subject invention.

FIG. 2 illustrates a methodology of call conferencing in accordance with the invention.

FIG. 3 illustrates more detailed system diagram of the telephone call processing system of the subject invention.

FIG. 4 illustrates a methodology of performing call conferencing in accordance with the invention.

FIG. 5 illustrates a methodology of processing greetings in accordance with the invention.

FIG. 6 illustrates a methodology of connecting a conference participant to the appropriate conference call session in accordance with the invention.

FIG. 7 illustrates a methodology of creating a new conference call in accordance with the invention.

FIG. 8 illustrates a methodology of processing a received facsimile in accordance with the invention.

FIG. 9 illustrates a methodology of capturing incoming information in accordance with the invention.

FIG. 10 illustrates a methodology of processing an e-mal address book in accordance with the invention.

FIG. 11 illustrates a methodology of managing a conference call session in accordance with the invention.

FIG. 12 illustrates a methodology of managing a session by a host in accordance with the invention.

FIG. 13 illustrates a methodology of managing a conference call session in a no-host manner in accordance with the invention.

FIG. 14 illustrates a general system configuration of the present invention.

FIG. 15 illustrates a sample PIN card that can be used to access a conference call in accordance with the invention.

FIG. 16 illustrates a block diagram of hospitality communications system in accordance with the subject invention.

FIG. 17 illustrates a methodology of a hospitality call management communications in accordance with the invention.

FIG. 18 illustrates a methodology of providing teleconferencing services for a hospitality environment in accordance with an aspect.

FIG. 19 illustrates a block diagram of a hospitality call management system in accordance with the subject invention.

FIG. 20 illustrates a flow block diagram of a hospitality call management system in accordance with the subject invention.

FIG. 21 illustrates an alternative flow block diagram of a hospitality call management system in accordance with the subject invention.

FIG. 22 illustrates a methodology of configuring a hospitality provider communications system for web-supported call management in accordance with an innovative aspect.

FIG. 23 illustrates a methodology of managing a guest call via the call management system.

FIG. 24 illustrates a methodology of processing call management for a VoIP phone system in accordance with an aspect.

FIG. 25 illustrates a methodology of processing a teleconferencing session for a guest of the hospitality provider in accordance with an innovative aspect.

FIG. 26 illustrates a methodology of activating a guest calling card according to an aspect.

FIG. 27 illustrates a methodology of activating a guest calling card according to an aspect.

FIG. 28 illustrates a hospitality/call management system that employs an artificial intelligence component which utilizes machine learning and reasoning, and which facilitates automating one or more features in accordance with the subject innovation.

FIG. 29 illustrates a block diagram of an exemplary call management communications system in accordance with an innovative aspect.

FIG. 30 illustrates a block diagram of a computer operable to support the call management and/or hospitality provider systems of the disclosed architecture.

FIG. 31 illustrates a schematic block diagram of an exemplary computing environment that supports the call management and hospitality provider back-office systems in accordance with the subject invention.

### DETAILED DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

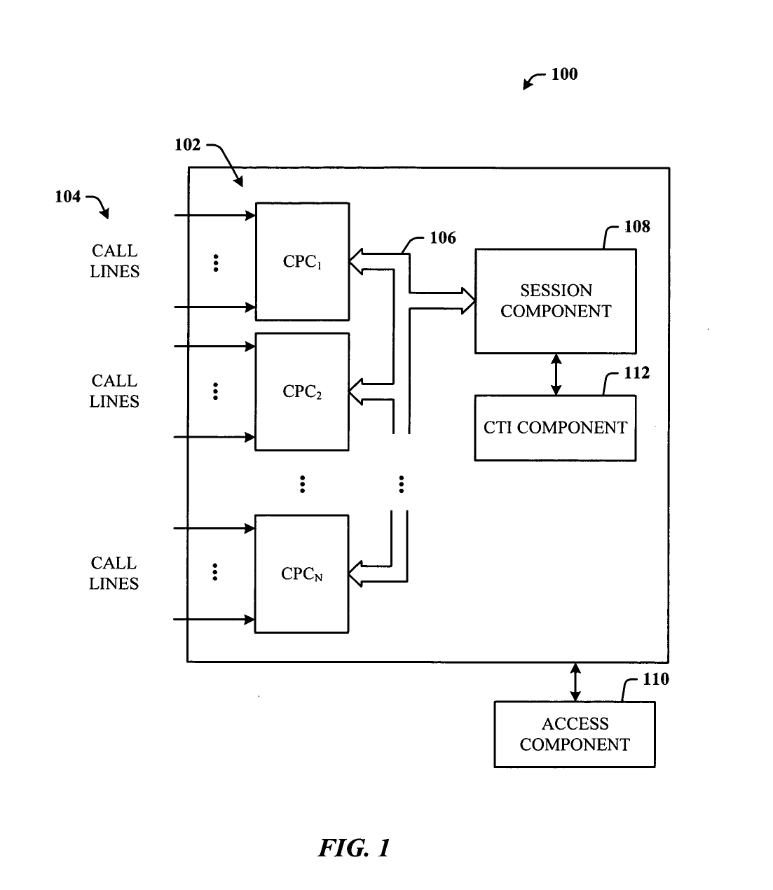

Referring now to FIG. 1, there is illustrated a call session system 100 in accordance with the subject invention. The system 100 includes one or more call processing components 102 (denoted CPC₁,CPC₂, . . . ,CPC_{N}) that provide the capability to receive and transmit calls via call lines 104 (e.g., as provided by digital T1 and E1 communications architectures), and process signals and data for at least the management of call conferencing. The one or more call processing components 102 intercommunicate control signals and data across a non-voice communications bus 106. In accordance with a novel aspect of the subject invention, a session component 108 resides on the bus 106 in communication with the one or more call processing components 102 to facilitate routing of one or more of the calls across the non-voice communications bus 106, which is a departure from the designed purpose of the bus 106.

The session component 108 bridges the one or more call processing components 102 across the bus 106 in such a way that is significantly more efficient and allows for dynamic assignment of ports across the multiple cards at the time of receiving or initiating a call. Conventionally, software is written to allocate an assigned port for a received call, and use that port until the call is finished. In the system of the invention, the system does not even consider which port to allocate until the call starts, allocates the first available port, and dynamically allocates more or less ports as the demand increases and decreases. During the session, the system knows which ports are being used, and at the end of the session, releases the ports back into the pool of ports to be re-utilized.

In support of call management, the session component 108 can manage a single call across processing resources (e.g., DSP—digital signal processor resources) of at least two of the CPCs (e.g., CPC₁ and CPC₂). Additional features of echo cancellation, noise reduction, volume control, etc., are facilitated by dedicating some of the DSP resources of the CPCs for these purposes. It is within contemplation of the subject invention that other functions can be dedicated to additional DSP resources where suitable code is provided.

The system 100 also includes an access component 110 that facilitates user interaction with features provided in code by the session component 108. The system 100 exposes itself as a network-based API (application program interface) that facilitates processing of general functions, for example, “dial this number”, “play this .wav file on this line”, “bind this line into this conference call”, and “create a new conference call.” In contrast, the session component 108 manages the ports and DSP resources as one large entity of ports and resources.

The session component 108 interfaces to a CTI (computer telephony interface) component 112 that exposes itself as a remote Java™ API to which the access component 110 interfaces. Thus, the graphical user interface provided by a browser interfaces to the CTI component 112, and not to the session component 108 and underlying hardware and software. Note that although the CTI component 112 is shown internal to the system 100, it can be implemented as a separate entity external to the system 100, as hosted on a personal computer, for example.

The bus 106 is a secondary bus that typically handles signals and data, and which are non-voice communications. One example of the communications architecture employed by the bus 106 is an MVIP (multi-vendor integration protocol) architecture. Another more recent enhancement to the MVIP architecture provides the basis for H.100 bus and H.110 bus architectures, such as found on a model AG4000C board, and other suitable boards manufactured by NMS Communications, of Framingham, Mass.

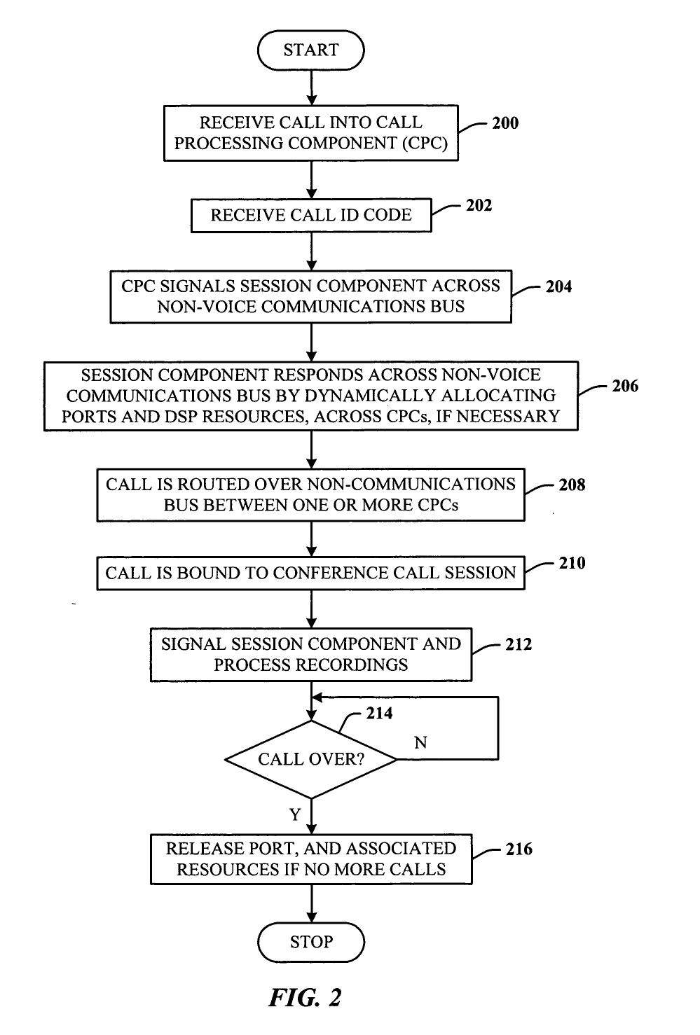

Referring now to FIG. 2, there is illustrated a methodology of call conferencing in accordance with the invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 200, a call is received at a CPC. The user, in accordance with the invention, also provides an ID, as indicated at 202. This can be a participant ID that indicates the caller is a participant in a conference call session, or a host ID that indicates the caller will be the host of the conference call. At 204, the CPC that received the call signals the session component across the non-voice communications bus. At 206, the session component responds across the non-voice communications bus by dynamically allocating ports and DSP resources, across CPCs, if necessary. If necessary, at 208, the call is routed over the non-voice communications bus to be processed by the assigned resources on a different CPC than the one that received the call. At 210, the call is bound to a conference call session. At 212, the session component is signaled with respect to one or more recordings that can be played in association with the call. At 214, the system checks if the call is over. If no, flow loops back to keep checking. If yes, at 216, the session component disconnects the call and releases the associated port. If the call is the last of the session, the associated DSP resources will also be released for reassignment to another call session.

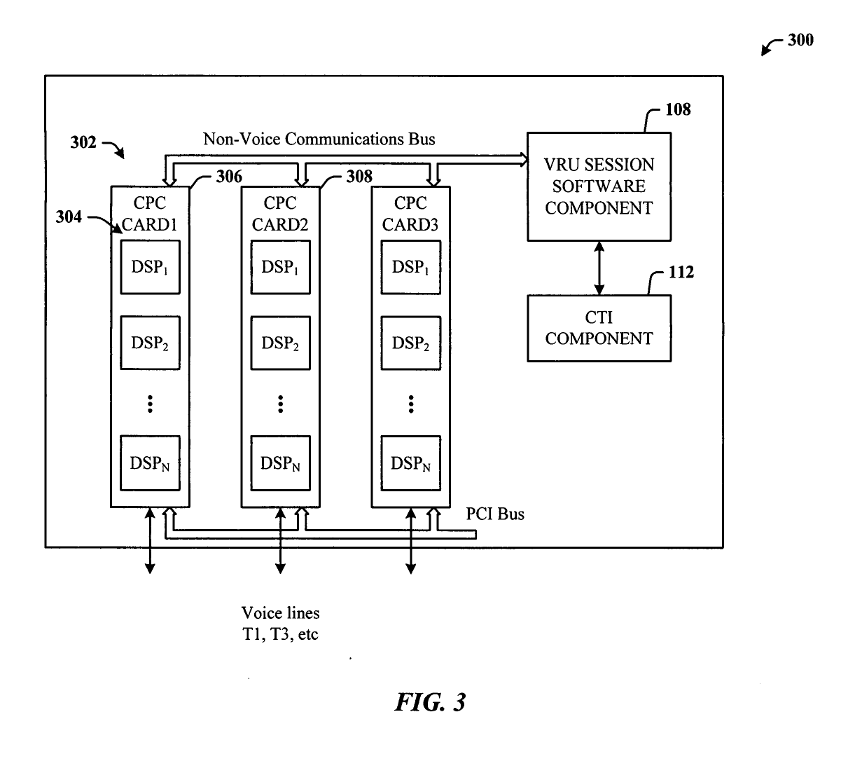

Referring now to FIG. 3, there is illustrated more detailed system diagram of the telephone call processing system 300 of the subject invention. The system 300 (similar to system 100 of FIG. 1) receives incoming calls over voice lines, such as T1 and E1 digital communications connections. One or more separate lines can be provided for each CPC card 302 (denoted here as CPC Card1, CPC Card2, and CPC Card3). Each of the CPC cards 302 includes DSP resources 304 (represented as DSP blocks DSP₁, DSP₂, . . . ,DSP_{N}) to which an incoming call is assigned for processing. In accordance with the subject invention, each of the DSP resources 304 is allocated to perform same or different tasks. For example, a first DSP resource (DSP₁) can be allocated for echo cancellation, a second DSP resource (DSP₂) can be allocated for volume control, and a third DSP (not shown) can be allocated for noise reduction, all of which are associated with one or more calls.

The allocation of such DSP resources 304 is accomplished by the session software component 108 (designated as the VRU—voice response unit) that communicates associated commands across the non-voice communications bus to the respective CPC cards 302. Moreover, a call received at a first CPC card 306 can be routed across to a second CPC card 308, via the non-voice communications bus. Thus, the burden of call processing can be scaled to another card. Ultimately, all CPC processing cards and incoming voice lines appear to be one large bound conference-calling platform.

The CTI component 112 facilitates interfacing to the system 300 such that high level commands can be processed and communicated to the session component 108 for execution across the non-voice communications bus 106 to the CPC cards 302.

At a higher level, the many call conferencing benefits and functions can be performed in accordance with the system 300 of the subject invention. A user can interface to the system 300 to facilitate a conference call, by initiating contact with prospective participants, binding callers to a specific conference call session, muting, disconnecting, and performing many other functions in accordance with the subject invention.

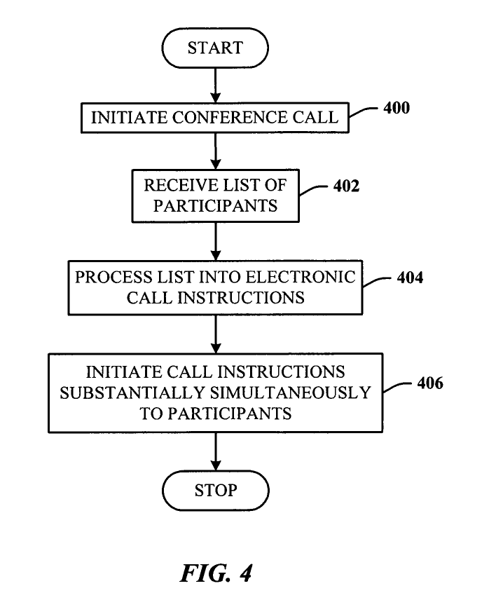

Referring now to FIG. 4, there is illustrated a methodology of performing call conferencing in accordance with the invention. The system is capable of simultaneously dialing several participants at once and binding them to a conference call. Accordingly, at 400, a conference call session is initiated. At 402, a list of participants is received. At 404, the list is processed into electronic call instructions. At 406, the call instructions are processed to initiate calls substantially simultaneously to all participants on the list.

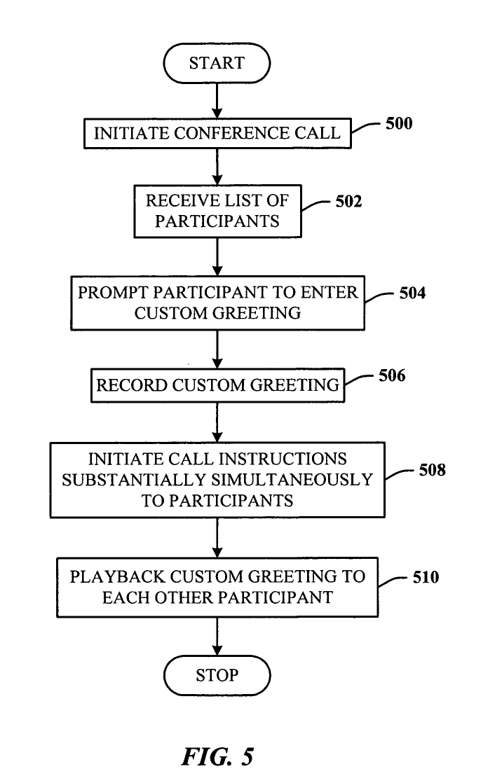

Referring now to FIG. 5, there is illustrated a methodology of processing greetings in accordance with the invention. The software is also capable of calling a conference call host (referred to herein as a “hosted” conference call session), prompting the host for a custom greeting, recording the custom greeting, and replaying the custom greeting to other participants invited to the conference call. Accordingly, at 500, a conference call session is initiated. At 502, a list of participants is received and processed. At 504, a host is called and prompted to enter a custom greeting. At 506, the custom greeting is input by the host and stored. At 508, call instructions are initiated substantially simultaneously to all participants. At 510, the custom greeting is played back to the session participants who are then logged in to the session. Where a host is not designated, this is referred to herein as a “non-hosted” conference call session.

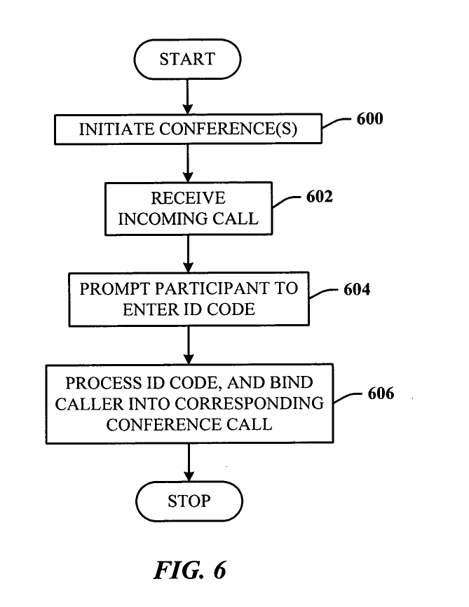

Referring now to FIG. 6, there is illustrated a methodology of connecting a conference participant to the appropriate conference call session in accordance with the invention. At 600, several conference call sessions have been initiated and/or are in session. At 602, the system receives an incoming call of a session participant. At 604, the system prompts the caller to enter an ID code. At 606, the system processes the ID code, and binds the caller as a participant into the conference call session that corresponds to the ID code.

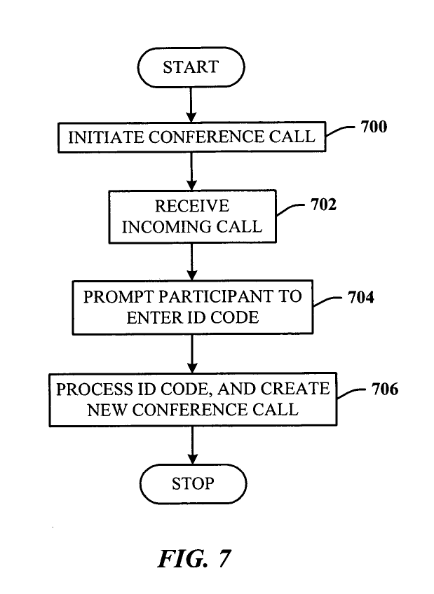

Referring now to FIG. 7, there is illustrated a methodology of creating a new conference call in accordance with the invention. At 700, a conference call is initiated. At 702, an incoming call is received. At 704, the caller is prompted for an ID code. At 706, the ID code is processed, and a new conference call session created.

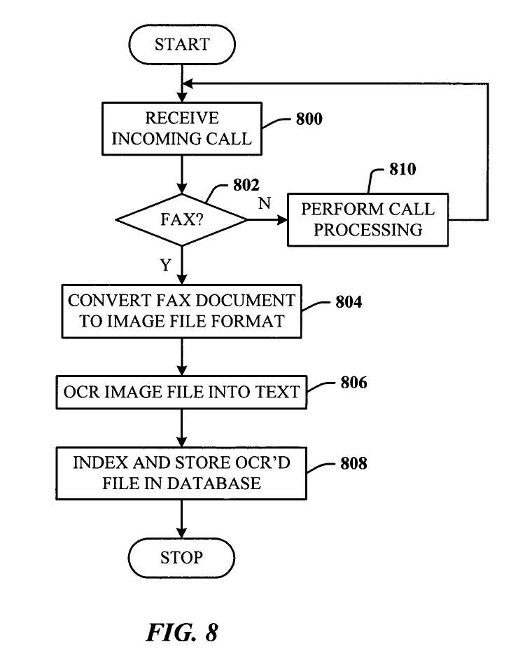

Referring now to FIG. 8, there is illustrated a methodology of processing a received facsimile in accordance with the invention. At 800, the system receives an incoming call, and analyzes the call signals. At 802, if the incoming call is a fax transmission, flow is to 804 to convert the fax document to an image file format (e.g., a TIFF file) and store the converted document to a hard drive or other storage device. At 806, the image file is processed by optical character recognition (OCR) into plain text data. At 808, the plain text of the fax can be written to a file for indexing and insertion into a database. At 802, if the call is not a fax, flow is to 810 to process the call normally as a voice call.

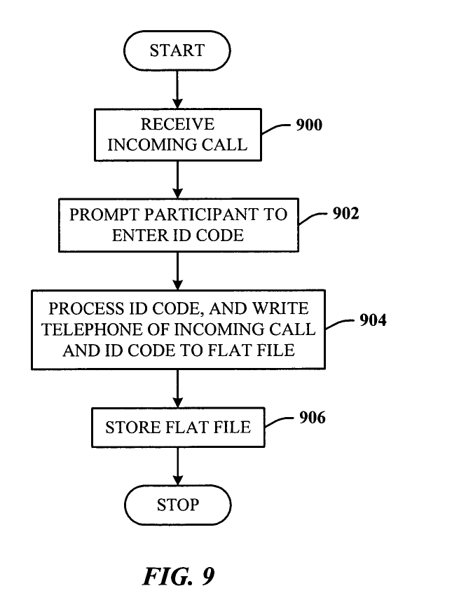

Referring now to FIG. 9, there is illustrated a methodology of capturing incoming information in accordance with the invention. At 900, an incoming call is received. At 902, the caller is prompted to enter an ID code. At 904, the system processes the ID code, and writes the telephone number and ID code of the prospective conference call participant in association therewith to a flat file. At 906, the flat file is then stored for later processing.

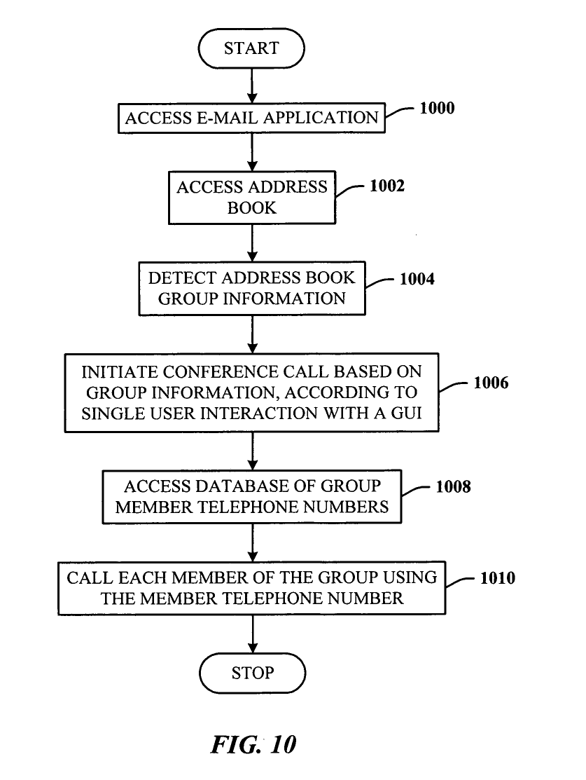

Referring now to FIG. 10, there is illustrated a methodology of processing a list of names for a conference call in accordance with the invention. The list of names can be obtained from any data source. For example, in one implementation, a user may establish “groups” from an address book such as that found in Microsoft Outlook™, for example, and the software is capable of allowing the conference manager to invite each member of the group to participate in the conference call via a graphical user interface (GUI) with a single input action (mouse-click). Accordingly, at 1000, a data source (e.g., an e-mail application) is accessed. At 1002, a list of names (e.g., an address book) is accessed therefrom. At 1004, grouping information (e.g., from within the address book) is detected, if available. At 1006, a conference call session is initiated (e.g., based on the grouping information), and according to a single user click and/or interaction with the GUI. At 1008, a database of telephone numbers is accessed from a database. At 1010, each member of the list (e.g., the group) is called using the corresponding member telephone number. As indicated supra, the list of names and any associated grouping information can be obtained from any program and/or data source such as a contacts file stored in an e-mail program, a contacts file stored in a PDA, a cell phone address book, and so on.

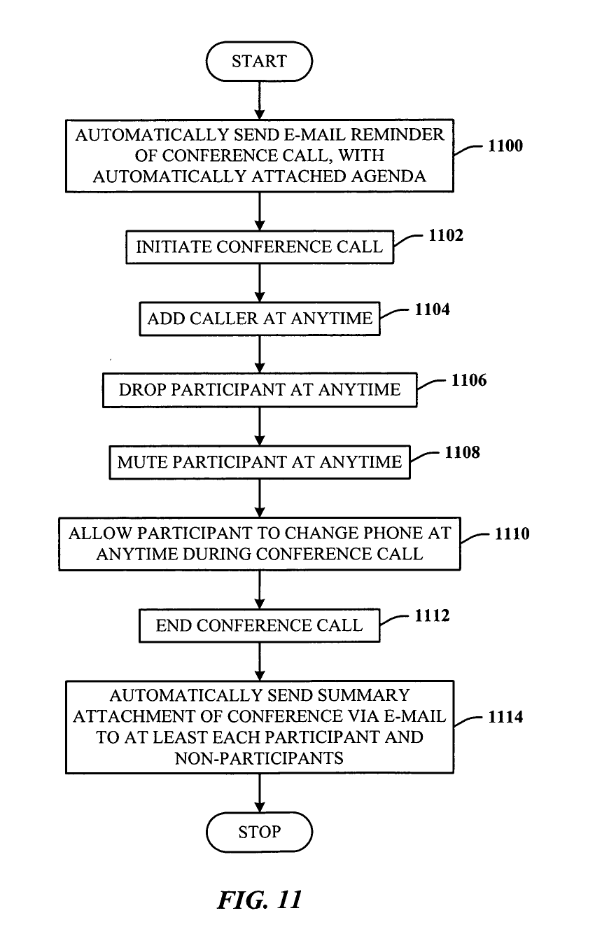

Referring now to FIG. 11, there is illustrated a methodology of managing a conference call session in accordance with the invention. The system of the subject invention permits callers to be added, muted, and/or dropped at any time, and allows callers to change phones in mid-call. The system can call out to participants simultaneously, eliminating the need to wait for everyone to get online, or can let them call in, adding them at any time. The system can send reminders using a variety of mechanisms with the agenda and minutes automatically prior to calls, during calls, and in written summaries of conference call sessions afterwards. In one implementation, the system enables up to fifty-five participants to be bound at one time into a conference call session. However, this is not to be construed as limiting, since additional capacity in terms of hardware and/or software facilitates the addition of a greater number of session participants is within contemplation and scope of the invention.

Accordingly, at 1100, the system can automatically send a reminder to each potential session participant via e-mail or other messaging mechanisms (e.g., SMS-short message service, MMS-multimedia messaging service, . . . ), and with an automatically attached session agenda and file attachments. At 1102, the conference call session is initiated. At 1104, a caller can be added to the session at anytime. At 1106, a session participant can be dropped from the session at anytime. At 1108, a session participant can be muted at anytime. At 1110, a session participant can be allowed to change telephones at anytime during the session. At 1112, the conference call session ends. At 1114, a session summary can be automatically sent to each participant and/or to any non-participant.

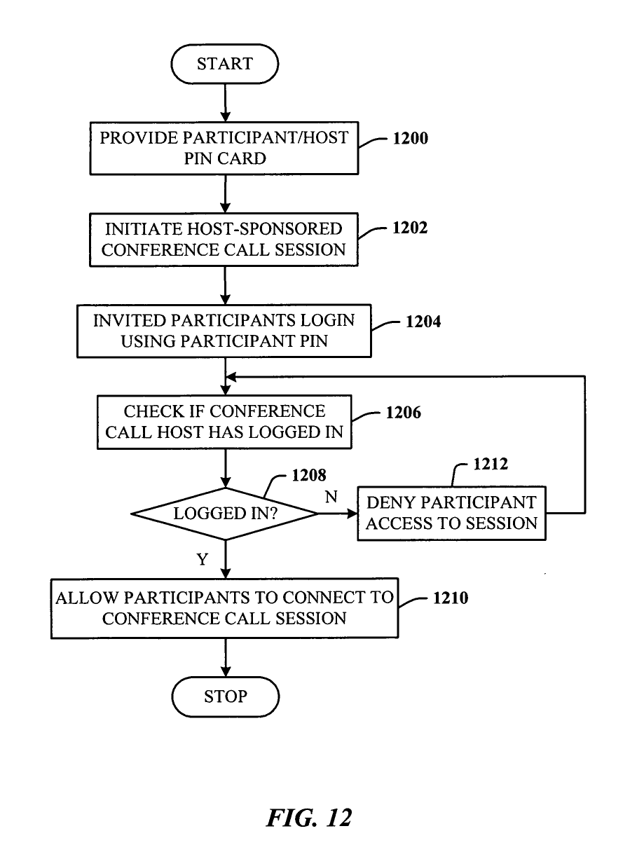

Referring now to FIG. 12, there is illustrated a methodology of managing a session by a host in accordance with the invention. Conference calls may be managed from virtually any computing device and/or telephone, e.g., a touch-tone phone, mobile telephone, personal computer or a wireless PDA (e.g., a Palm™ PDA). More particularly, in keeping with a particularly preferred aspect of the invention, users or participants can dial-in using a Participant Identification Number (PIN), while the host dials in with another PIN (called a host PIN) that can be used to control when the conference starts, for example. In this way, only when the host dials-in will the other callers be connected. This is a particularly effective method for a manager or other supervisor to maintain better control over their conference call session. Additionally, it allows customers the opportunity to issue credit card size conference calling cards containing a permanent host PIN and participant PIN to each person who wishes to make conference calls, without ever even having to use a browser interface.

At 1200, a participant/host card is provided with corresponding PINs for each function. At 1202, the caller initiates a host-sponsored (or hosted) conference call session. At 1204, invited participants log in using the participant PIN. At 1206, the system determines if the host has logged in to start the session. If so, at 1208, flow is to 1210 to allow callers to check in to the session as participants. Alternatively, if the host has not logged in to start the session, no other participants will be allowed to log in, as indicated by 1212. Flow is then back to 1206 to continue checking for the host login.

The browser interface can be used when more console control is desired over the call, such as viewing who is participating in the call and how each participant has been in the session and the how long the session has been in existence. A feature called “Hosted Meet Me” helps prevent potential overuse and misuse of single conferencing PINs. It also prevents the conference call from remaining “open” after the host hangs up. Hosted Meet Me is ideal for large companies that distribute thousands of conferencing PINs to managers, and for university virtual classrooms where the call cannot start until the professor dials in.

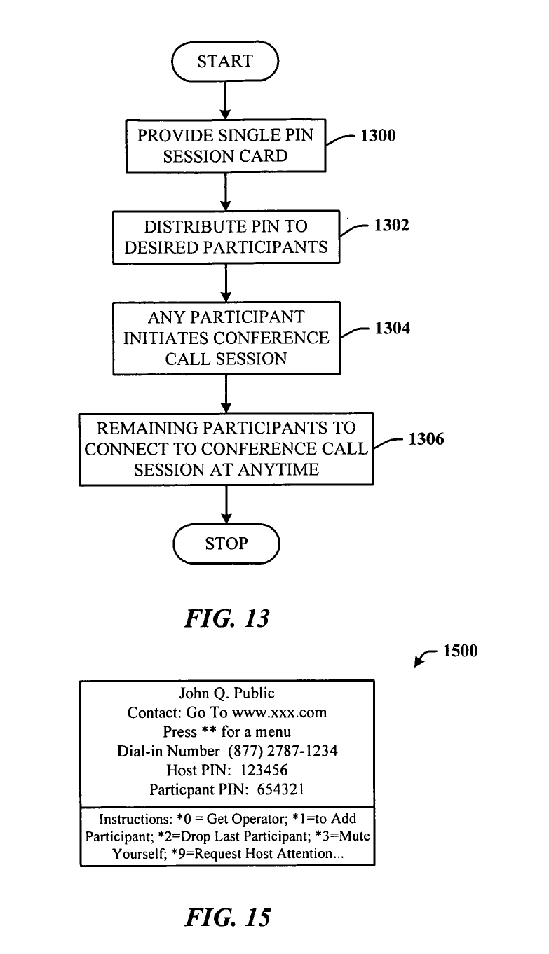

Referring now to FIG. 13, there is illustrated a methodology of managing a conference call session in a no-host (or non-hosted) manner in accordance with the invention. A single PIN “Meet Me” feature is also provided via the subject invention. This feature issues an active PIN number that can be distributed to any person desired to be in a conference. No Host PIN is created, so whenever any one of these participants calls in, a conference call session can begin with any of the other people who received that PIN. This single PIN Meet Me feature is desirable in many situations where a group of people need equal ability for any of them to start a conference call, such as among an engineering team.

Accordingly, at 1300, a single PIN session number is provided, in the form of, for example, a card. At 1302, the PIN is distributed to potential conference participants. It is to be appreciated that the PIN can be provided by many other conventional means, for example, e-mail, telephone call, messaging to a messaging device, and so on. At 1304, any person who has the PIN can dial-in to start the conference call session. At 1306, the remaining participants can call to connect to the session at any time.

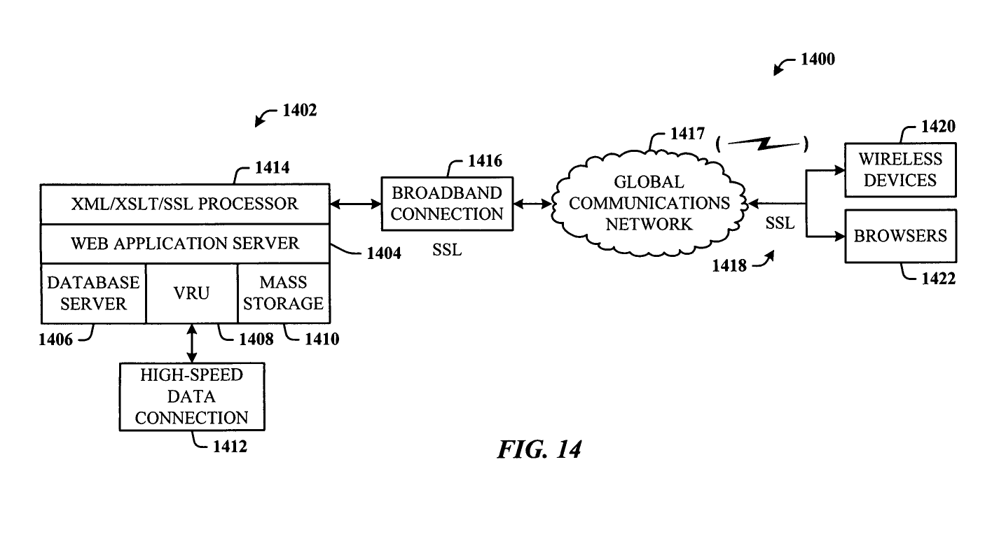

Referring now to FIG. 14, there is illustrated a general system configuration 1400 of the invention. The system 1400 includes a platform 1402 that hosts at least the data management tool, here called a web application server 1404. The server 1404 provides a common layer to underlying services that include a database server 1406, a VRU (voice response unit) 1408 (also called an interactive VRU or IVRU, and similar to the system 100 of FIG. 1 and system 300 of FIG. 3) and mass storage system 1410. The VRU 1408 facilitates interactive calling features for a user via remote touchtone signals and/or speech recognition facilities and to voice data to the caller such that the caller can make choices in response to predetermined options presented by the system.

The platform 1402 can utilize at least one multi-channel data communication connection 1412 (e.g., T1, DS3) into the VRU subsystem 1408 for communicating voice information and interacting with features of the platform 1402. As indicated previously, the invention can accommodate user communication from virtually any accessible network node. To facilitate such an interface, the platform 1402 can include a processor 1414 suitable for XML (eXtensible Markup Language), XSLT (XML Stylesheet Language: Transformations), and SSL processing. The processor 1414 can also access web-based services utilizing SOAP (Simple Object Access Protocol). SOAP employs XML syntax to send text commands across the network using HTTP (HyperText Transport Protocol). Thus, there is a high-speed connection 1416 (e.g., broadband) that interfaces to the processor layer 1414 for use with multiple communication exchanges with remote users disposed on a global communication network 1417. The remote users can access the platform system 1402 via a SSL or other secure connection 1418 using portable wired/wireless devices 1420, and by way of the associated browsers 1422.

The VRU subsystem 1408 also facilitates the recording of voice messages (e.g., voice mail) for access and retrieval at a later time. Additionally, the message is not restricted to access by a single user, but can be accessed by multiples users who are given the access authority (e.g., a PIN for a conference call session). The voice messages can be retrieved and presented via any number of different methods. For example, a user can access the voice message via a cell phone, VoIP phone, IP phone, a computer or computing device (e.g., desktop, laptop, tablet PC, PDA, and so on) by connecting to the system and providing sufficient credentials to access the message(s).

FIG. 15 illustrates a sample PIN card 1500 that can be used to access a conference call in accordance with the invention. The card 1500 includes access information in the format of a URL (uniform resource locator) address that can be used to enter into a conference call as a participant (using the participant PIN) or the host (using the host PIN). Other selections allow the caller to connect to an operator, access an options menu, add a participant, increase volume, drop the last participant, record a session, mute yourself, decrease volume, and unmute/request host attention, for example.

Communications between the CTI 112 and the session component 108 of FIG. 1, which together can be considered the VRU 1408 of FIG. 14, can be accomplished using many different programming codes. The code can facilitate a typical dial in process, entering of a PIN number, putting oneself on mute, and adding a participant using a DTMF (dual-tone multi-frequency) response of * 1, for example. Both people then hang up.

This first section involves the VRU detecting and receiving an incoming call, and then sending a message to a SCP (Service Control Point). SCP is an SS7 (Signal System 7) signaling point containing a centralized database or enhanced service application. SS7 is an out-of-band signaling system that provides fast call setup (using circuit-switched connections) and transaction capabilities for remote database interactions. For example, toll-free number translation databases, or a HLR (home location register) and a VLR (visitor location register) databases in wireless networks. Once the user has input a PIN code, the SCP is contacted.

In one implementation, the VRU detects and receives an incoming call, and then sends a message to a SCP (service control point). SCP is an SS7 (Signaling System 7) signaling point containing a centralized database or enhanced service application. SS7 is an out-of-band signaling system that provides fast call setup (using circuit-switched connections), and transaction capabilities for remote database interactions, such as for example, toll-free number translation databases, a HLR (home location register) and/or VLR (visitor location register) databases in wireless networks. Once the user has input a PIN code, the SCP is contacted. Continuing with a generalized description of one SCP-related implementation, next, the PIN code is validated using the SCP, and the connection is accepted. A conference call session is created, a voice file can be played, and a participant added to the conference call session. DSP resources are also managed to allocate ports for the calls. The conference call session can be configured by the session host. A session participant can be called in preparation for entry into the conference call session, the, a caller can be added to the conference call session, a session participant removed from the current conference call session, and the conference call session terminated. In another implementation, the VRU does not send messaging via an SCP unit, but utilizes other means.

Hospitality Environment Communications Architecture

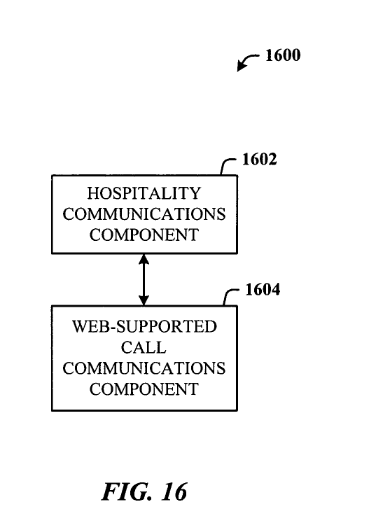

Referring now to FIG. 16, there is illustrated a block diagram of hospitality communications system 1600 in accordance with the subject invention. The system 1600 finds application in any hospitality environment such as hotels or any other lodging facilities (e.g., resorts, retreats, specialized conference facilities, dormitories, lodges, campgrounds . . . ). The system 1600 can include a hospitality communications component 1602 which can comprise a local telephone switching system such as a PABX (private automatic branch exchange) system, and/or a VoIP (voice over IP) that facilitates access to an IP network (e.g., the Internet) for IP packet-based calls thereover.

The hospitality communications component 1602 interfaces to a web-supported telephone call communications component 1604 that utilizes IP network services for connecting and routing calls, for example. The terms web-supported are intended to at least mean IP-capable for any packet network, as well as capable of being disposed on the Internet, and capable of receiving and processing web services. In one implementation, the web-supported telephone communications component 1604 facilitates teleconferencing of multiple callers and telephones (e.g., wired and/or wireless) into a call session. This is described in greater detail infra. Thus, when employed in combination with the web-supported telephone communications component 1604, the hospitality environment can provide additional flexibility for guest communications services in a more robust manner than conventional systems.

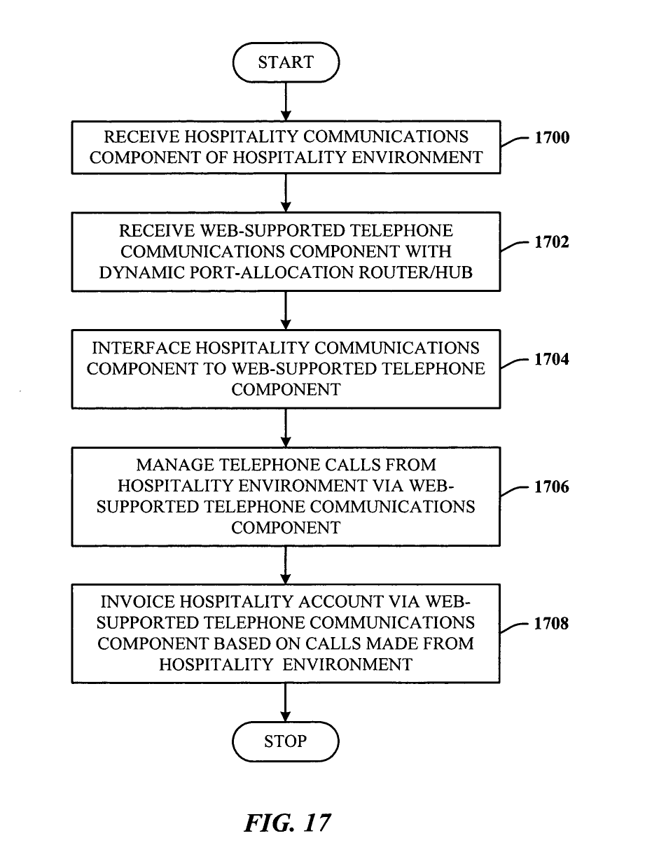

Referring now to FIG. 17, there is illustrated a methodology of a hospitality call management communications in accordance with the invention. At 1700, a hospitality communications component (e.g., a PABX) of a hospitality environment is received. At 1702, a web-supported telephone communications component is received that includes a dynamic port allocation router/hub. At 1704, the web-supported telephone communications component is interfaced to the hospitality communications component to facilitate hospitality environment telephone communications via the web-supported telephone communications component. At 1706, the web-supported telephone communications component manages calls from the hospitality environment. At 1708, a hospitality account associated with the hospitality environment is invoiced for guest charges via the web-supported telephone communications component based on calls made from the hospitality environment.

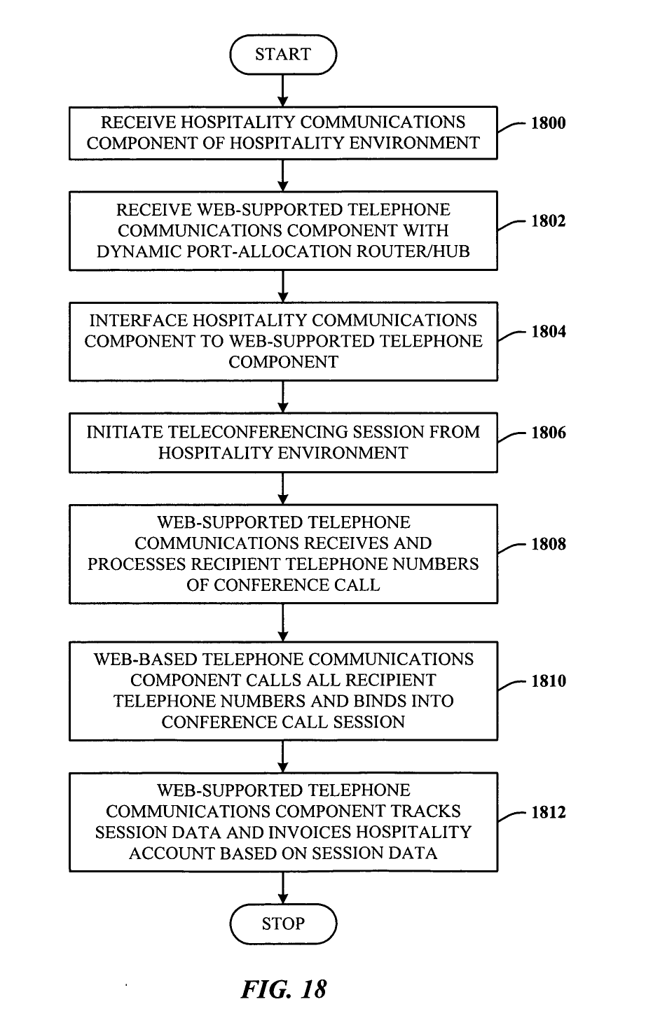

FIG. 18 illustrates a methodology of providing teleconferencing services for a hospitality environment in accordance with an aspect. At 1800, a hospitality communications component (e.g., a PABX) of the hospitality environment is received. At 1802, a web-supported telephone communications component is received that includes a dynamic port allocation router/hub for call routing and binding. At 1804, the web-supported telephone communications component is interfaced to the hospitality communications component to facilitate hospitality environment telephone call management. At 1806, a teleconferencing session is initiated from the hospitality environment by the guest selecting a special input code from a room handset. At 1808, the web-supported teleconferencing communications component receives and processes recipient telephone numbers for the conference call session. At 1810, the web-supported telephone communications component calls all recipient telephone numbers and binds the terminated calls in the conference call session. At 1812, the web-supported telephone communications component tracks session data and invoices the hospitality account based on the session data.

The web-supported telephone communications component can process and bind not only telephone call calls into the conference session, but also other computing devices to for one-to-many and many-to-many call interaction using two pr more wired and/or wireless voice-capable and/or text messaging devices (e.g., cellular telephones, PDAs, IM messaging devices, etc.). Additionally, a call conference participant can also participate in the call session using messaging technology such as SMS (short message service), MMS (multimedia message service), and the like. Moreover, the web-supported telephone communications component also facilitates video conferencing with voice and other multimedia content, as desired.

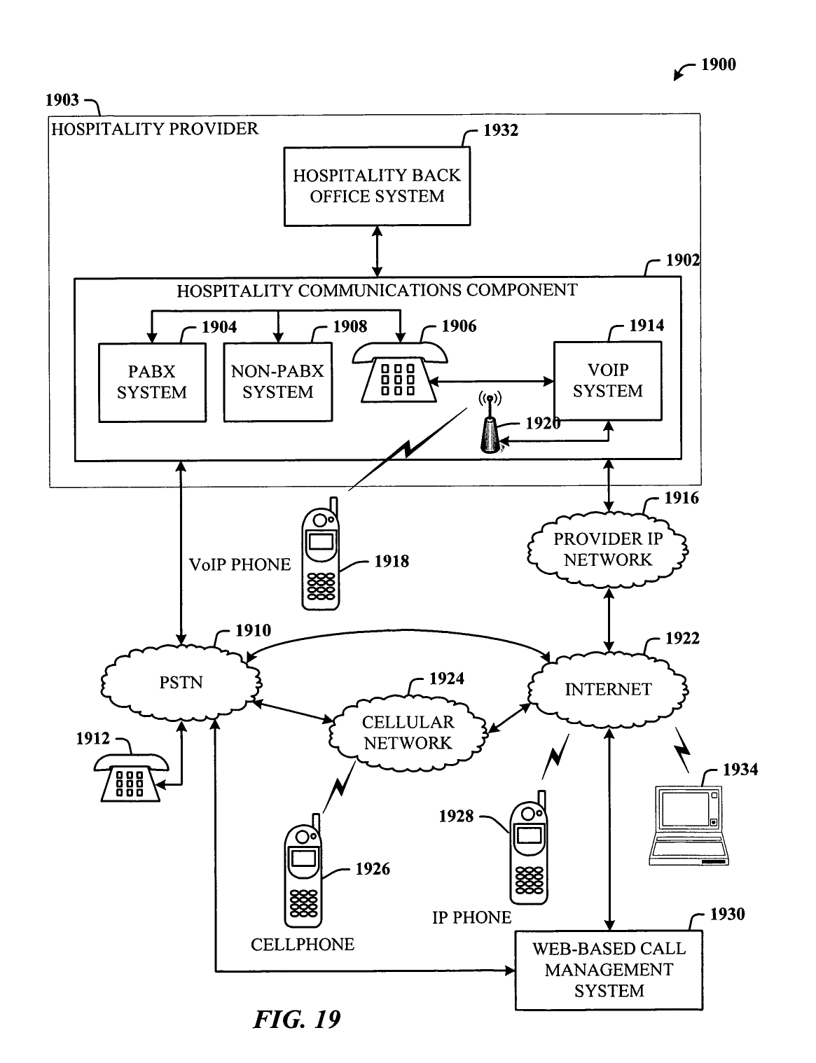

FIG. 19 illustrates a block diagram of a hospitality call management system 1900 in accordance with the subject invention. The system 1900 can include a hospitality communications component 1902 (similar to component 1602 of FIG. 16) of a hospitality provider 1903 that facilitates call circuit-switched and/or IP-packet communications for the hospitality provider location. As indicated supra, the component 1902 can include a PABX subsystem 1904 that automatically processes and routes outgoing calls from telephones 1906 (e.g., a guest room telephone and a front desk telephone) of the provider 1903 or to the telephones 1906 from incoming calls, and/or a non-PABX telephone system 1908 such that each of the telephones 1906 has a line or can share a line to the outside. The hospitality component 1902 interfaces to the PSTN (public switched telephone network) system 1910 for conventional circuit-switch communications to handset connected thereto (e.g., a telephone handset 1912).

The hospitality component 1902 can also include a VoIP system 1914 that facilitates VoIP voice communications of an IP network 1916 from the telephone 1906, which can be a VoIP telephone that is wired to the VoIP system 1914. The VoIP system 1914 can also be accessed by a wireless VoIP telephone 1918 that can be used by a guest, for example, rather than the hospitality provider phone 1906 (e.g., of a guest room or front desk phone). The VoIP phone 1918 can communicate with the VoIP system 1914 via a wireless access point 1920 that interfaces to the VoIP system 1914. Thus, a guest can use the wireless VoIP phone 1918 or the hospitality VoIP phone 1906 to make calls over the IP network 1916 to the Internet network 1922 to terminate at other telephone handsets (e.g., handset 1912).

The Internet network 1922 interfaces to a cellular network 1924, which can further interface to the PSTN system 1910 such that VoIP calls initiated at the hospitality environment can be terminated at the conventional handset 1912. Conversely, incoming calls from the PSTN 1910 (e.g., via the phone 1912), the cellular network 1924 (e.g., via a cell phone 1926), and/or the Internet 1922 (e.g., via an IP phone 1928) can be terminated at the hospitality provider 1903 via handsets 1906 that interface to the PABX system 1904, the non-PABS system 1908, and/or the VoIP system 1914. Call charges can be received and processed via a hospitality provider back office system 1932.

The system 1900 can also include a web-supported call management system 1930 that includes hardware and/or software for managing calls from the hospitality provider via the hospitality communications component 1902. For example, as indicated herein, the hospitality provider 1903 can offer teleconferencing capabilities that are managed by the web-supported call management system 1930. A guest can enter a special input code (e.g., *1) via the guest phone 1906. In one implementation, in response to receiving the code, the hospitality component 1902 automatically dials a toll-free number (e.g., an 800 number) that connects to the call management system 1930. Thereafter, at least a hospitality PIN (a unique PIN assigned only to the provider 1903) and the guest room number are transmitted via the PABX system 1904 or the non-PABX system 1908 over the PSTN 1910 directly and/or indirectly to the call management system 1930. This can be directly to the management system 1930 via the PSTN 1910, indirectly to the call management system 1930 by way of the PSTN 1910 and the Internet 1922, and/or indirectly to the call management system 1930 by way of the PSTN 1910, the cellular network 1924 and the Internet 1922.

Once received, the call management system 1930 open a call conferencing session to which other callers can connect and be bound to. For example, a caller that uses the phone 1912 can dial into the conference call session via the PSTN 1910 by calling a toll-free number that is picked up by the call management system 1930 and entering a PIN value that is uniquely assigned to the session. Similarly, users of the VoIP phone 1918, the cell phone 1926, and the IP phone 1928 can separately dial-in to the call management system 1930 via the VoIP system 1914, the cellular network 1924 and the Internet 1922, respectively, in order to enter the conference call session.

Alternatively, the telephone numbers of the session recipients are known, and have been submitted to the call management system 1930. The call management system 1930 initiates the conference session at a predetermined time by calling each of the submitted phone numbers, which can include connecting to the handset 1912, the cell phone 1926, the VoIP phone 1918, the handset 1906, and/or the IP phone 1928 at the appointed time. When the calls are received into the call management system 1930, each is bound into the conference session. Other callers who happen to call into the management system 1930, but who are not registered with the session will not be allowed to enter the session. It is to be appreciated that computing devices that include voice capability can also connect into the conference session via a wired and/or wireless circuited switched or packet-switched network. For example, a user with a portable computer 1934 can be called and bound into a conference call session.

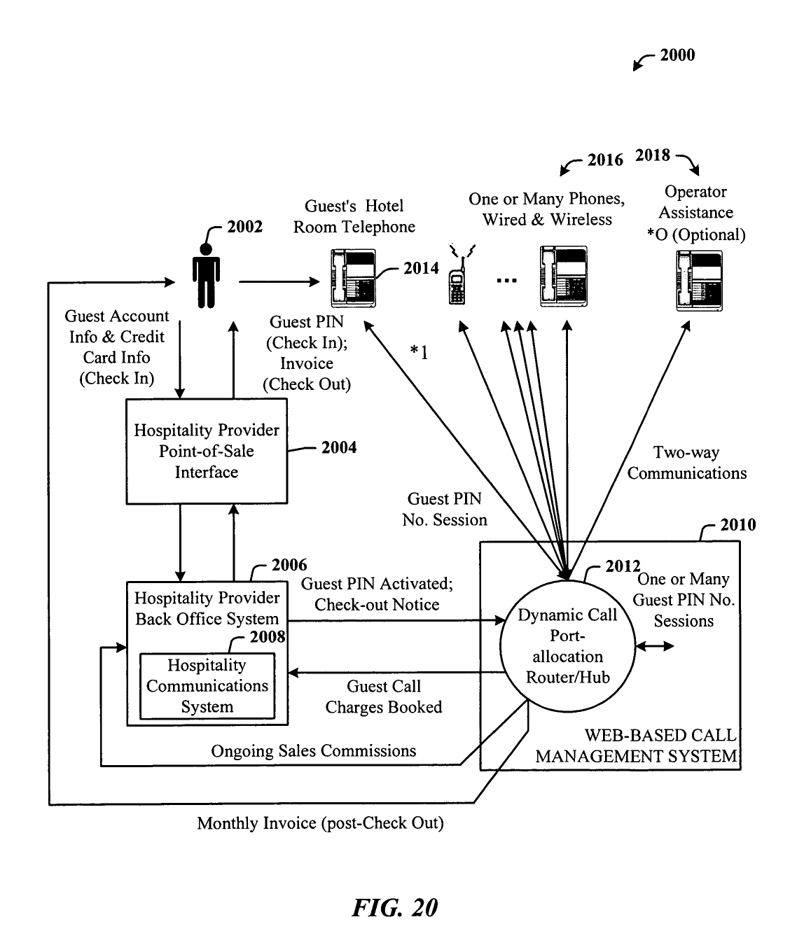

FIG. 20 illustrates a flow block diagram of a hospitality call management system 2000 in accordance with the subject invention. When a guest 2002 checks into a hospitality provider (e.g., a hotel), he or she is requested to provide account and/or and financial information during the check-in process. This can occur at a hospitality point-of-sale (POS) 2004. In this particular implementation, the guest can also receive calling card with a unique PIN and a predetermined number of free minutes for voice calls, for example. It is to be understood that other services can also be provided (video content, messaging services, . . . ). The POS system 2004 interfaces to a hospitality back-office system 2006 which receives, stores and/or processes the guest information. The back-office system 2006 can also include a hospitality communications system 2008 which facilitates the communications for the provider and all guest rooms. This can include wired and/or wireless voice, data, and VoIP systems, for example, such as were mentioned as part of the hospitality communications component 402 of FIG. 4.

The back-office system 2006 facilitates communication of the guest PIN to a web-supported call management system 2010. This process can also include transmission of the guest personal information (e.g., name, address, . . . ) and financial/account information (e.g., credit card, bank account, . . . ). However, neither is the guest financial/account information nor the guest personal information required to be communicated to the call management system 2010. Simply the fact that the guest PIN has been communicated in combination with hospitality provider information to the call management system 2010 can suffice to activate the guest PIN. Once the PIN has been transmitted to the management system 2010, it can be activated for use. Thereafter, when the guest calls the toll-free number and enters the PIN, call services (e.g., teleconferencing) can be made available to the guest via the call management system 2010. It is to be understood that the PIN card is not the only means of placing voice calls. The guest can utilize the hospitality telephone system as they would conventionally, without accessing the call management system 2010.

The call management system 2010 can also include a dynamic port-allocation router/hub system 2012 that can bind multiple calls into a call session. For example, where the guest chooses to initiate or participate in a conference call session via a guest telephone 2014, the hub system 2012 includes hardware and/or software to make this happen. When the guest utilizes the call management system 2012 and any services provided thereof, this use can be tracked and charged back to the guest when the guest checks out of the hospitality environment. Thus, if initiating and/or participating in a conference call from the guest phone 2014 by selecting a predetermined code (e.g., *1), this information can be tracked and billed back to the guest. The hub system 2012 facilitates the guest calling or connecting to (e.g., for messaging) one or more wired and/or wireless phones 2016. At anytime during the call session, whether a single PIN card call, a conference call, or the like, the guest can also select another predetermined code (e.g., *O) for operator assistance 2018 on the same voice channel as the call. Thus, two-way communications then exists between the operator assistant 2018 and the guest telephone 2014. This can be made optional.

Once the call is over, the call management system 2010 transmits the call session information back to the provider back-office system 2006 for charging against the guest room (or guest account). When the guest checks out, he or she can see the charges incurred on the check-out invoice for the call(s) made.

With respect to the provider/call management system provider business relationship, the call management system 2010 can transmit to the provider back-office system 2006 ongoing sales commission information. Thus, it is to be appreciated that the more calls made by provider guests can translate into better sales commissions for the hospitality provider, as can be coordinated between the system 2010 and the back-office system 2006. Where the guest chooses to continue using the call management system 2010 after leaving the hospitality provider, the guest can be invoiced on a regular basis (e.g., monthly).

The call management system 2010 by way of the dynamic port allocation hub system 2012 can accommodate many simultaneous call sessions, whether single calls or conference calls. Additionally, it is to be understood that although depicted as a single system, the call management system 2010 can include multiple hub systems 2012 interconnected for call management.

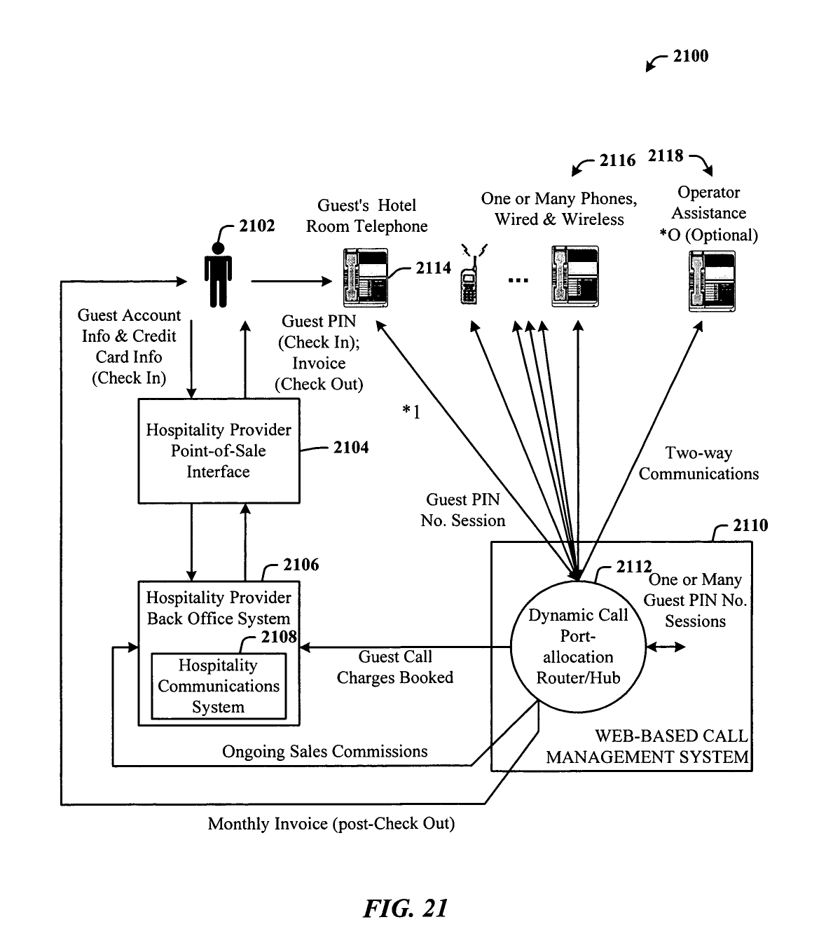

FIG. 21 illustrates an alternative flow block diagram of a hospitality call management system 2100 in accordance with the subject invention. Here, the guest PIN is not activated at guest check-in, but is provided to the guest at check-out time. When a guest 2102 checks into a hospitality provider (e.g., a hotel), he or she is requested to provide account and/or and financial information during the check-in process. This can occur at a hospitality POS 2104. It is to be understood that other services can also be provided (video content, messaging services, . . . ) by the hospitality provider.

The POS system 2104 interfaces to a hospitality back-office system 2106 which receives, stores and/or processes the guest information. The back-office system 2106 can also include a hospitality communications system 2108 which facilitates the communications for the provider and all guest rooms. This can include wired and/or wireless voice, data, and VoIP systems, for example, such as were mentioned as part of the hospitality communications component 402 of FIG. 4.

The back-office system 2106 facilitates communication of a hospitality provider PIN to a web-supported call management system 2110. This process can also include transmission of the guest personal information (e.g., name, address, . . . ) and financial/account information (e.g., credit card, bank account, . . . ). However, neither the guest financial/account information nor the guest personal information is required to be communicated to the call management system 2110. When the provider PIN is communicated to the system 2110, additional information can be communicated thereto, for example, the guest room number. This makes it easier to track the guest who is making the calls. It is to be understood that the hospitality PIN is not the only means for placing voice calls by the guest. The guest can utilize the hospitality telephone system as they would conventionally, without accessing the call management system 2110.

In another alternative implementation, the guest receives no special unique PIN at check-in. When the guest selects a special code (e.g., presses *1) from their room phone, the PABX system transmits the hotel ID and room number to the call management system to begin the call. Thereafter, the caller can press the special code again (e.g., *1) for each successive new participant to allow those participants into the conference call session. When the conference call is terminated, the call management system sends the total call minutes and charges to the hotel property management system via that property management system's relevant API for inclusion on the invoice for that room number.

The call management system 2110 can also include a dynamic port-allocation router/hub system 2112 that can bind multiple calls into a call session. For example, where the guest chooses to initiate or participate in a conference call session via a guest telephone 2114, the hub system 2112 includes hardware and/or software to make this happen. When the guest utilizes the call management system 2112 and any services provided thereof, this use can be tracked and charged back to the provider, which guest room number is used to find and charge the associated guest when the guest checks out of the hospitality environment. Thus, if initiating and/or participating in a conference call from the guest phone 2114 by selecting a predetermined code (e.g., *1), this information can be tracked and billed back to the guest. The hub system 2112 facilitates the guest calling or connecting to (e.g., for messaging) one or more wired and/or wireless phones 2116. At anytime during the call session, whether a single PIN card call, a conference call, or the like, the guest can also select another predetermined code (e.g., *O) for operator assistance 2118 on the same voice channel as the call. Thus, two-way communications then exists between the operator assistant 2118 and the guest telephone 2114. This can be made optional.

Once the call is over, the call management system 2110 transmits the call session information back to the provider back-office system 2106 for charging against the guest room (or guest account). When the guest checks out, he or she can see the charges incurred on the check-out invoice for the call(s) made.

With respect to the provider/call management system provider business relationship, the call management system 2110 can transmit to the provider back-office system 2106 ongoing sales commission information. Thus, it is to be appreciated that the more calls made by provider guests can translate into better sales commissions for the hospitality provider, as can be coordinated between the system 2110 and the back-office system 2106. Where the guest chooses to continue using the call management system 2110 after leaving the hospitality provider, the guest can be invoiced on a regular basis (e.g., monthly).

The call management system 2110 by way of the dynamic port allocation hub system 2112 can accommodate many simultaneous call sessions, whether single calls or conference calls. Additionally, it is to be understood that although depicted as a single system, the call management system 2110 can include multiple hub systems 2112 interconnected for call management.

As a general, but not all-inclusive, summary, the guest can access the call management system in a number of ways. Firstly, the guest can access the system by selecting a special code on the guest telephone in the guest room. Secondly, the system can be accessed during the guest stay by utilizing the guest calling card that can be issued at check-in the provider POS. Thirdly, the system can be accessed after the guest has left the provider location by utilizing the guest calling card that was either provided to the guest at check-in, or at check-out. In any case, the provider can be credited with commissions for helping to bring the guest on as a customer of the call management system.

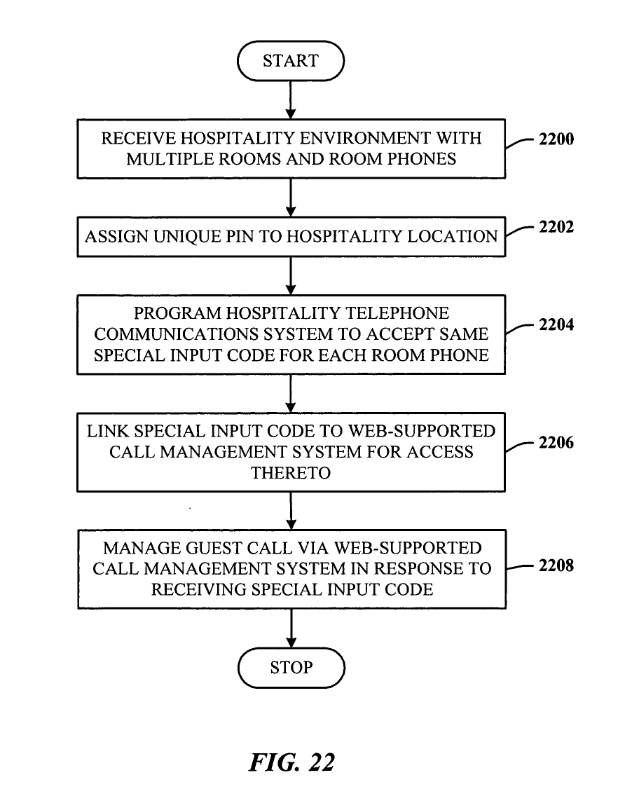

FIG. 22 illustrates a methodology of configuring a hospitality provider communications system for web-supported call management in accordance with an innovative aspect. At 2200, a hospitality environment is received having multiple rooms with room phones. At 2202, a unique PIN is assigned top the hospitality provider. At 2204, the hospitality provider communications system is programmed to accept the same special code for each guest phone. At 2206, the special input code is linked to the web-supported call management system. At 2208, a call made to the call management system by the guest is managed based on the special input code. Thus, if the special input code relates to call conferencing, the guest can be charged accordingly for those services.

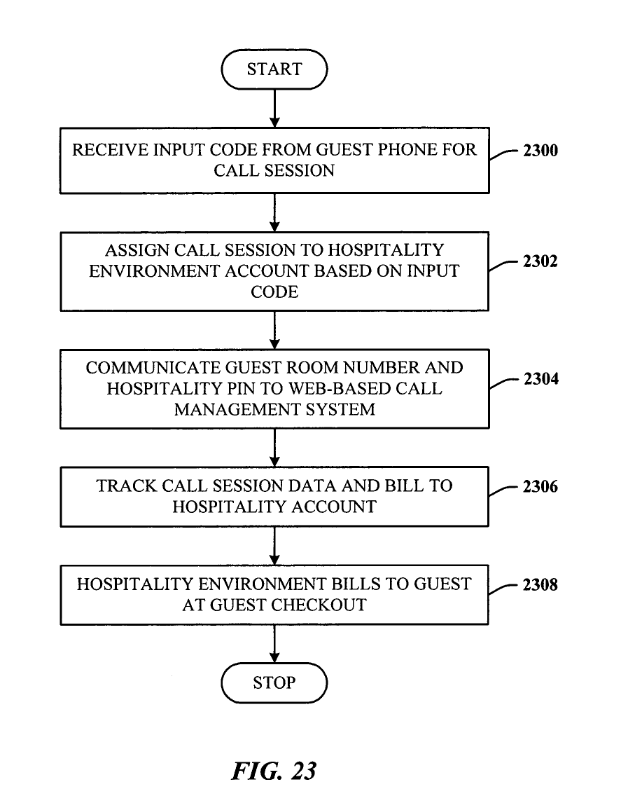

FIG. 23 illustrates a methodology of managing a guest call via the call management system. At 2300, the guest inputs a code via the guest phone for a call session. At 2302, the call session is assigned to the hospitality provider account based on the input code. For example, it is to be understood that the input code can be a conventional calling card code which does not invoke call management in accordance with the subject invention. At 2304, when selecting a call management code via the guest telephone, the guest room number and provider PIN code can be transmitted to the call management system via the toll-free connection. At 2306, the call session is tracked by the call management system for billing back to the hospitality provider account. At 2308, the call management system can transmit not only the call session information but also the guest room number so that the provider can properly invoice the guest at check-out time.

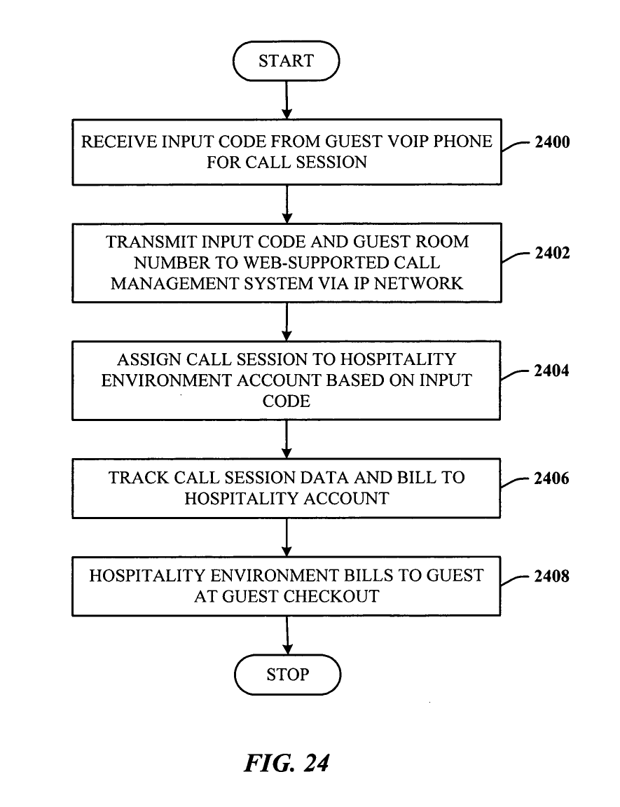

FIG. 24 illustrates a methodology of processing call management for a VoIP phone system in accordance with an aspect. At 2400, the guest inputs a special hospitality provider code via the room VoIP phone. At 2402, the VoIP system receives the special code input and routes the code information along with guest room number and provider PIN to the call management system over an IP network. The routing information can include an IP address associated with the call management system. At 2404, the call session is configured and assigned to the provider account. At 2406, the call session can be tracked and billed back to the provider account. At 2408, based on the guest room number provided back from the call management system, the provider can bill the guest at guest check-out time.

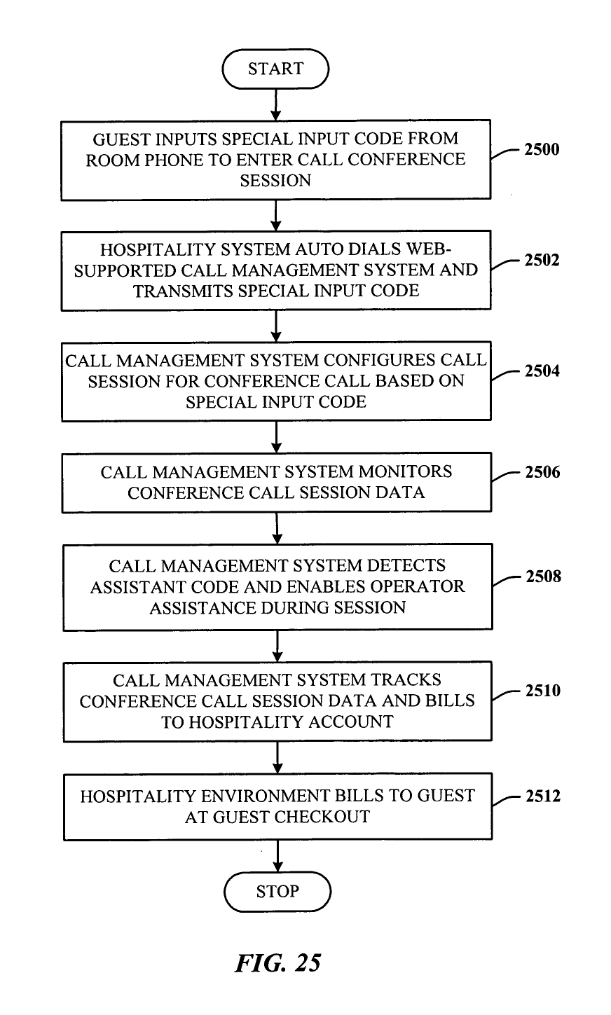

FIG. 25 illustrates a methodology of processing a teleconferencing session for a guest of the hospitality provider in accordance with a innovative aspect. At 2500, the guest inputs a special input code (e.g., *1) via the guest telephone that indicates the guest wants to participate in a conference call session, or initiate a conference call session. At 2502, the hospitality system auto dials the web-supported call management system and transmits the special code. Additional information can also be transmitted, such as the provider PIN and guest room number. In one implementation, the guest financial information can also be transmitted such that the guest credit card, for example, is automatically charged for the session. At 2504, the call management system configures the call session as a conference call based on the special input code received from the provider system. At 2506, the management system monitors the session and records session data related to invoicing the guest when the session is over.

At 2508, the call management system detects an operator assistance code (e.g., *0) that was input by a call participant, and enables operator assistant on the same voice channel as the call session. It is to be appreciated that assistance can be provided via a means different than the same voice channel. For example, the assistance can be provided via messaging to the guest phone (e.g., SMS, MMS, . . . ). Alternatively, where the guest is logged into the Internet via a guest laptop computer, the assistance can be communicated via e-mail, and/or messaging directly to the guest laptop computer. At 2510, the call management system tracks session data (e.g., the number of minutes the session is active) and bills the provider account accordingly. This can include giving the provider a discounted charge such that the provider can add charges back to the session for billing to the guest. At 2512, the hospitality provider bills the guest at guest check-out.

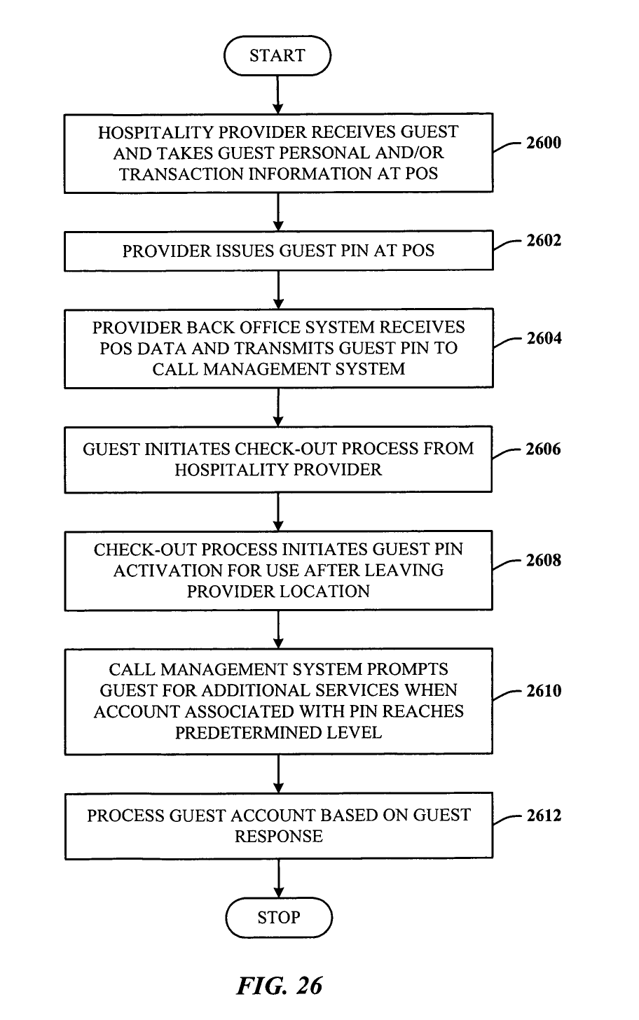

FIG. 26 illustrates a methodology of activating a guest calling card according to an aspect. At 2600, the hospitality provider receives the guest and takes guest personal and transaction information at check-in time via a POS system. At 2602, the provider issues the guest a PIN. At 2604, the provider back-office system receives the POS data and transmits the guest PIN to the call management system. At 2606, the guest initiates a check-out process from the provider location. At 2608, the check-out process initiates activation of the guest PIN for use after the guest leaves the provider location. At 2610, the call management system prompts the guest to pay for or subscribe to additional services when the account associated with the guest PIN reaches a predetermined minimum level. At 2612, the guest account is processed based on the guest response. For example, the guest card can be “recharged” to a predetermined limit based on payment by the guest. Additionally, or alternatively, the guest can select additional services.

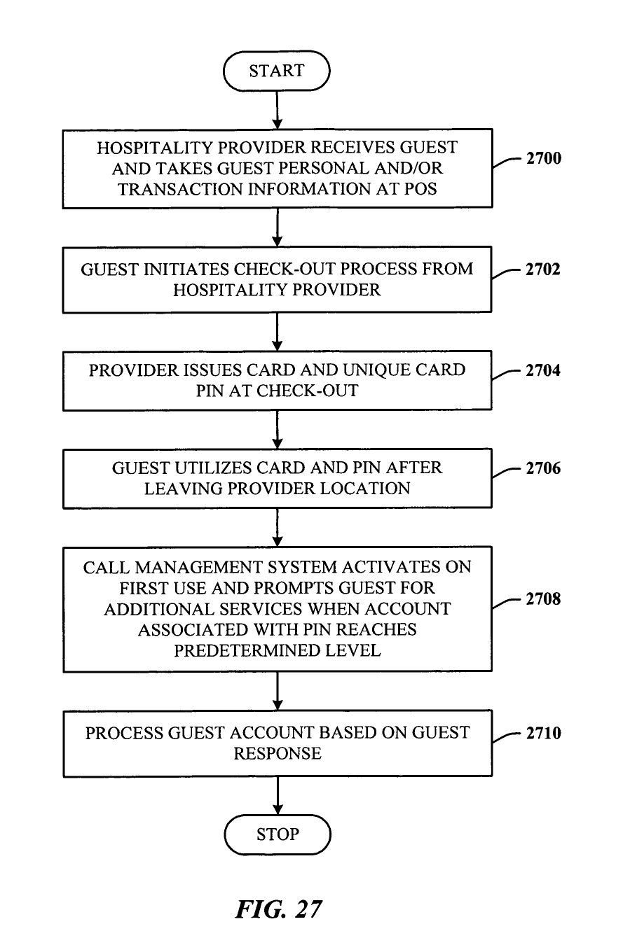

FIG. 27 illustrates a methodology of activating a guest calling card according to an aspect. At 2700, the hospitality provider receives the guest and takes guest personal and transaction information at check-in time via a POS system. At 2702, the guest initiates a check-out process from the provider location. At 2704, the provider issues a calling card with PIN at check-out. At 2706, the guest utilizes the card and PIN after leaving the provider location. At 2708, the call management system activates the PIN on first use, and prompts the guest to pay for or subscribe to additional services when the account associated with the guest PIN reaches a predetermined minimum level. At 2710, the guest account is processed based on the guest response. For example, the guest card can be “recharged” to a predetermined limit based on payment by the guest. Additionally, or alternatively, the guest can select additional services.

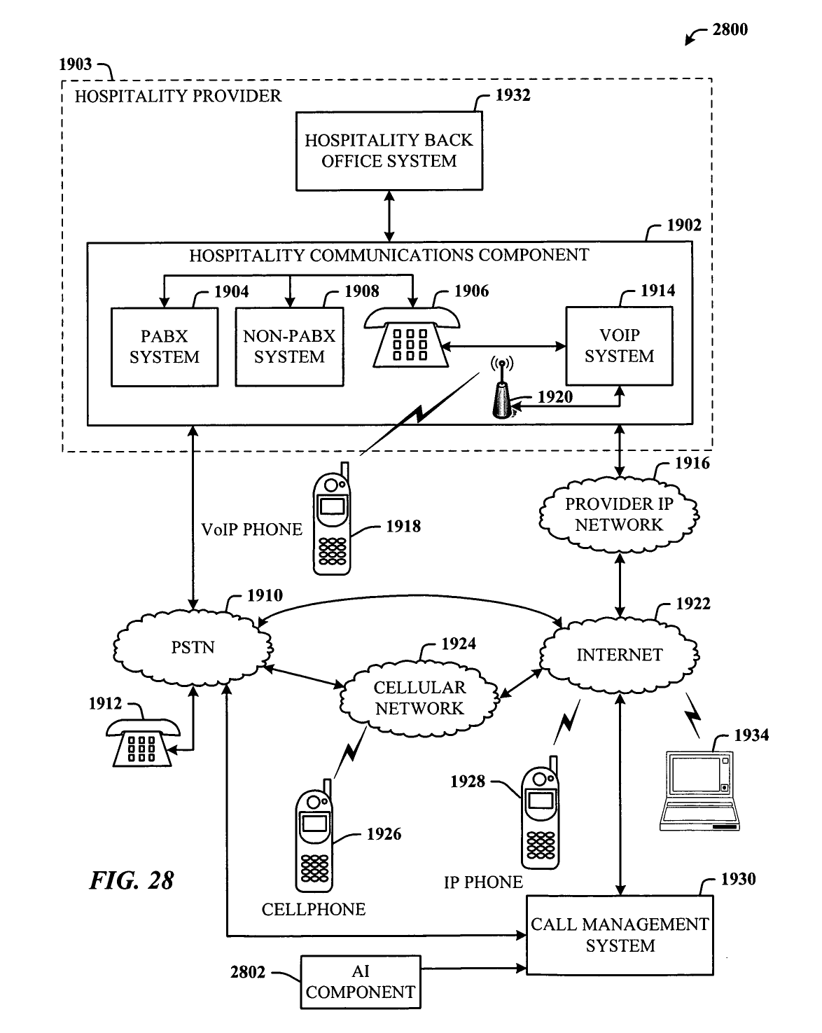

FIG. 28 illustrates a hospitality/call management system 2800 that employs an artificial intelligence (AI) component 2802 which utilizes machine learning and reasoning (MLR), and which facilitates automating one or more features in accordance with the subject innovation. The subject invention (e.g., in connection with selection) can employ various MLR-based schemes for carrying out various aspects thereof. For example, a process for determining what commission-based schemes to employ for the provider can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information, . . . ). For example, SVM's can be configured via a learning or training phase within a classifier constructor and feature selection module. Thus, the classifier(s) can be employed to automatically learn and perform a number of functions, including but not limited to determining according to predetermined criteria how much time to allot to a guest based on guest call activity. For example, if the guest has input the hospitality provider code for a conference call session, and from monitoring past activity by the call management system, determines that the guest routinely utilizes such a feature, the guest account can be automatically upgraded to a subscription level that provides the same services at a cheaper rate (rather than charging the guest additional fees for using over the allotted time).

In another example, based on the amount of hospitality provider activity, the MLR component of the call management system can learn and reason to automatically upgrade the provider to a higher level of subscription (or quality of service) based on the increased activity. When the provider activity is reduced, the MLR component can then automatically downgrade the level of services.

Where the guest routinely stays at a specific hospitality provider, which may be a chain of locations that the guest frequents, the MLR component can automatically invoke additional services for the guest based on this activity, and other criteria, as desired. These are only but a few examples of the automation that can be provided via the MLR component, and are not to be construed as limiting in any way. For example, based on guest profile information and past guest interaction, it can be reasoned and learned that the guest invoice can be automatically charged to a certain financial account.

Additionally, the MLR component can be employed to determine at what times to synchronize the call management system with the provider back-office system for the exchange of session information and other suitable information desired to account for session activity and provider commissions, for example.

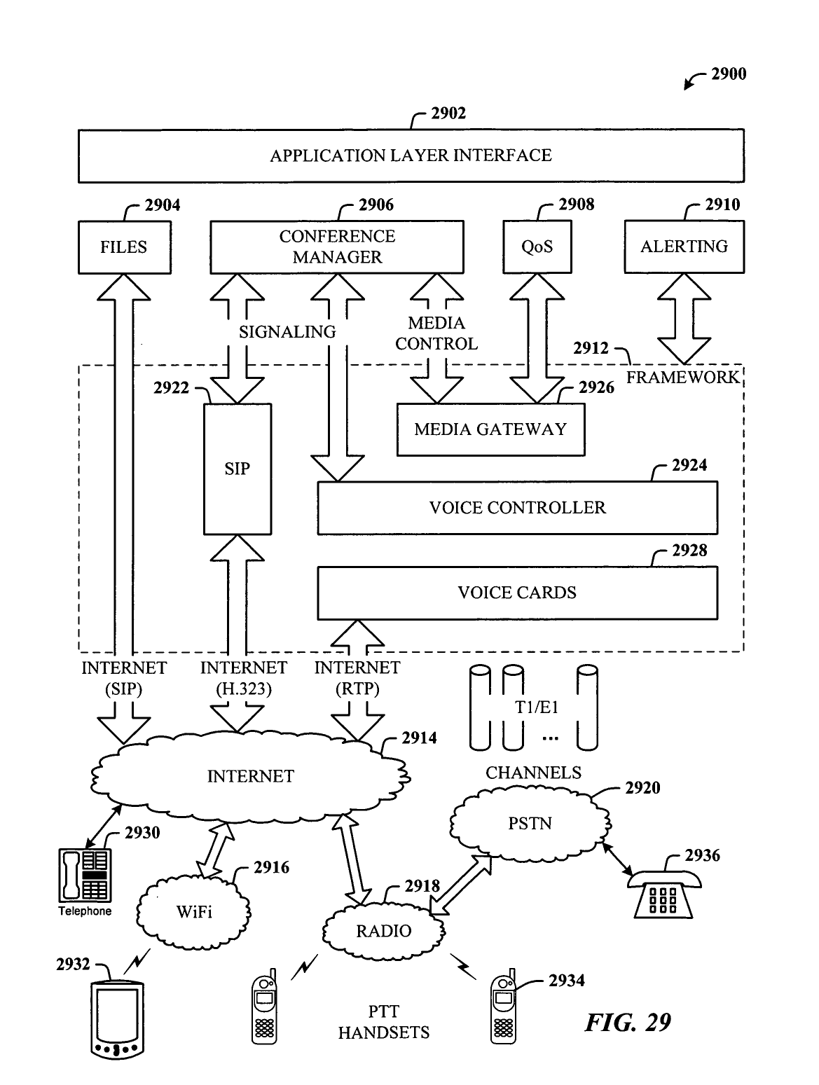

FIG. 29 illustrates a block diagram of an exemplary call management communications system 2900 in accordance with an innovative aspect. The call management system 2900 can be employed as a telephony conferencing manager for call conferencing, as desired. The system 2900 can include an application layer interface 2902 that provides exposure to overlying applications and underlying files 2904, a conference manager 2906, a quality-of-service (QoS) component 2908, and an alerting component 2910.

The system 2900 can include a communications framework 2912 via which the files 2904, conference manager 2906, (QoS) component 2908, and an alerting component 2910 can interface to external networks (e.g., the Internet 2914, a Wi-Fi network 2916, a radio network 2918, and/or a PSTN network 2920). The files 2904 can be communicated directly through the framework 2912 to the internet using SIP (session initiation protocol). The conference manager 2906 can interface to the Internet 2914 and other networks via a SIP component 2922 of the framework 2912, and therefrom via an H.323 protocol to the Internet 2914, to exchange signaling information.

H.323 is an international standard for multimedia communications over packet-switched networks, including LANs, WANs, and the Internet. H.323 is an “umbrella” specification that includes the standards H.323, H.225.0, H.245, the H.450-series documents, and the H.460-series. H.323 allows for the use of T.120 protocols for data collaboration and file transfer. T.120 is data conferencing standard that provides real-time communication between two or more entities in a conference. Applications specified as part of the T.120 family can include application sharing, electronic white boarding, file exchange, and chat. T.120 may be used stand-alone or in conjunction with other protocols, such as H.323 and SIP.

SIP is an IETF (Internet Engineering Task Force) standard for the establishment of multimedia sessions, which can be used for audio, video, messaging (e.g., instant messaging) and/or other real-time data communication sessions. The scope of SIP is relatively broad, including the establishment of virtually any kind of session between two parties.

The scope of H.323 can cover real-time voice (e.g., VoIP), video, and data communications over packet-switched networks. H.323 is designed to operate over IP networks, primarily, though H.323 can also operate over other packet-switched networks. H.323 includes multipoint voice and video conferencing capabilities.

The conference manager 2906 can also interface to internal components of the framework 2912. For example, signaling information can also be communicated to a voice controller component 2924 (e.g., an NMS natural access card by NMS Communications of Framingham, Mass.). Natural Access is a modular runtime and development environment for creating voice, fax, and call processing applications using NMS media processing platforms and can provide a consistent application programming interface (API) for integrating and presenting media and telecommunication capabilities to an application. Standard features include telephony call control, voice record and playback, tone detection and generation, and industry-standard H.100/H.110 switching support.

The conference manager 2906 can also interface to an internal media gateway component 2926 (e.g., fusion-an IP telephony API programming environment by NMS Communications) of the framework 2912. The conference manager 2906 can communicate at least media control information to the media gateway 2926. The QoS component 2908 can also interface to the media gateway 2926 to communicate QoS information. The alerting component 2910 can interface to the framework 2912 for the communication of alerts and notifications, for example.

The communications framework 2912 can also include one or more voice cards 2928 (e.g., a model CG6565 card by NMS Communications, or other similar vendor models having similar capabilities) that facilitate the conversion of voice signals into voice data for transmission to the Internet 2914 via RTP (real-time transport protocol) technology. RTP can be employed to support streaming real-time multimedia over IP in packets (e.g., voice and video over packet-switched networks).

The framework 2912 can also provide other types of packet communications channels such as T1 (1.54 Mbps) and/or E1 (2.048 Mbps) to the PSTN 2920. Thus, the system 2900 can facilitate communications to an IP phone 2930 for VoIP, a PDA 2932 in communications with the Wi-Fi network 2916, push-to-talk devices 2934 that communicate via the radio network 2918 (e.g. mesh radio networks for emergency services), and conventional telephones 2936 that connect to the PSTN system 2920, for example.

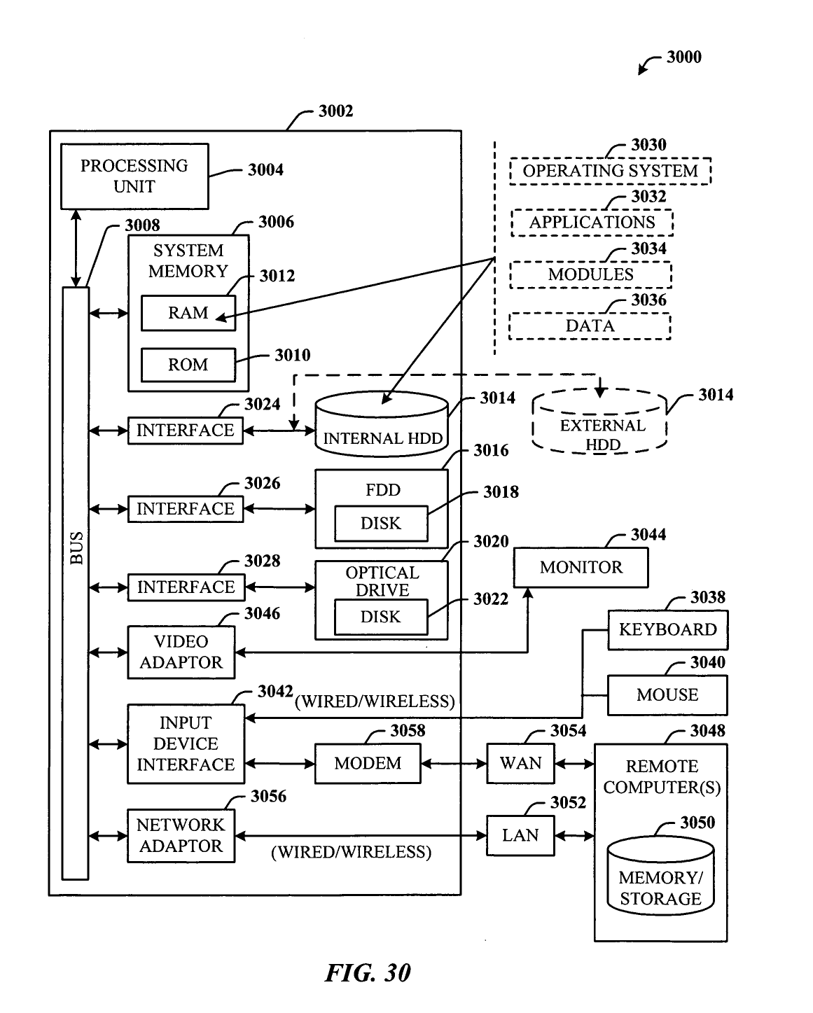

Referring now to FIG. 30, there is illustrated a block diagram of a computer 3002 operable to support the call management and/or hospitality provider systems of the disclosed architecture. In order to provide additional context for various aspects of the subject invention, FIG. 30 and the following discussion are intended to provide a brief, general description of a suitable computing environment 3000 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 30, there is illustrated an exemplary environment 3000 for implementing various aspects of the invention that includes a computer 3002, the computer 3002 including a processing unit 3004, a system memory 3006 and a system bus 3008. The system bus 3008 couples system components including, but not limited to, the system memory 3006 to the processing unit 3004. The processing unit 3004 can be any of various commercially available processors. Dual microprocessors and other multi-processor architectures may also be employed as the processing unit 3004.

The system bus 3008 can be any of several types of bus structure that may further interconnect to a memory bus (with or without a memory controller), a peripheral bus, and a local bus using any of a variety of commercially available bus architectures. The system memory 3006 includes read only memory (ROM) 3010 and random access memory (RAM) 3012. A basic input/output system (BIOS) is stored in a non-volatile memory 3010 such as ROM, EPROM, EEPROM, which BIOS contains the basic routines that help to transfer information between elements within the computer 3002, such as during start-up. The RAM 3012 can also include a high-speed RAM such as static RAM for caching data.

The computer 3002 further includes an internal hard disk drive (HDD) 3014 (e.g., EIDE, SATA), which internal hard disk drive 3014 may also be configured for external use in a suitable chassis (not shown), a magnetic floppy disk drive (FDD) 3016, (e.g., to read from or write to a removable diskette 3018) and an optical disk drive 3020, (e.g., reading a CD-ROM disk 3022 or, to read from or write to other high capacity optical media such as the DVD). The hard disk drive 3014, magnetic disk drive 3016 and optical disk drive 3020 can be connected to the system bus 3008 by a hard disk drive interface 3024, a magnetic disk drive interface 3026 and an optical drive interface 3028, respectively. The interface 3024 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 3002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 3012, including an operating system 3030, one or more application programs 3032, other program modules 3034 and program data 3036. All or portions of the operating system, applications, modules, and/or data can also be cached in the RAM 3012. It is appreciated that the invention can be implemented with various commercially available operating systems or combinations of operating systems.

A user can enter commands and information into the computer 3002 through one or more wired/wireless input devices, for example, a keyboard 3038 and a pointing device, such as a mouse 3040. Other input devices (not shown) may include a microphone, an IR remote control, a joystick, a game pad, a stylus pen, touch screen, or the like. These and other input devices are often connected to the processing unit 3004 through an input device interface 3042 that is coupled to the system bus 3008, but can be connected by other interfaces, such as a parallel port, an IEEE 1394 serial port, a game port, a USB port, an IR interface, etc.

A monitor 3044 or other type of display device is also connected to the system bus 3008 via an interface, such as a video adapter 3046. In addition to the monitor 3044, a computer typically includes other peripheral output devices (not shown), such as speakers, printers, etc.

The computer 3002 may operate in a networked environment using logical connections via wired and/or wireless communications to one or more remote computers, such as a remote computer(s) 3048. The remote computer(s) 3048 can be a workstation, a server computer, a router, a personal computer, portable computer, microprocessor-based entertainment appliance, a peer device or other common network node, and typically includes many or all of the elements described relative to the computer 3002, although, for purposes of brevity, only a memory storage device 3050 is illustrated. The logical connections depicted include wired/wireless connectivity to a local area network (LAN) 3052 and/or larger networks, for example, a wide area network (WAN) 3054. Such LAN and WAN networking environments are commonplace in offices, and companies, and facilitate enterprise-wide computer networks, such as intranets, all of which may connect to a global communications network such as the Internet.

When used in a LAN networking environment, the computer 3002 is connected to the local network 3052 through a wired and/or wireless communication network interface or adapter 3056. The adaptor 3056 may facilitate wired or wireless communication to the LAN 3052, which may also include a wireless access point disposed thereon for communicating with the wireless adaptor 3056.

When used in a WAN networking environment, the computer 3002 can include a modem 3058, or is connected to a communications server on the WAN 3054, or has other means for establishing communications over the WAN 3054, such as by way of the Internet. The modem 3058, which can be internal or external and a wired or wireless device, is connected to the system bus 3008 via the serial port interface 3042. In a networked environment, program modules depicted relative to the computer 3002, or portions thereof, can be stored in the remote memory/storage device 3050. It will be appreciated that the network connections shown are exemplary and other means of establishing a communications link between the computers can be used.

The computer 3002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11× (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

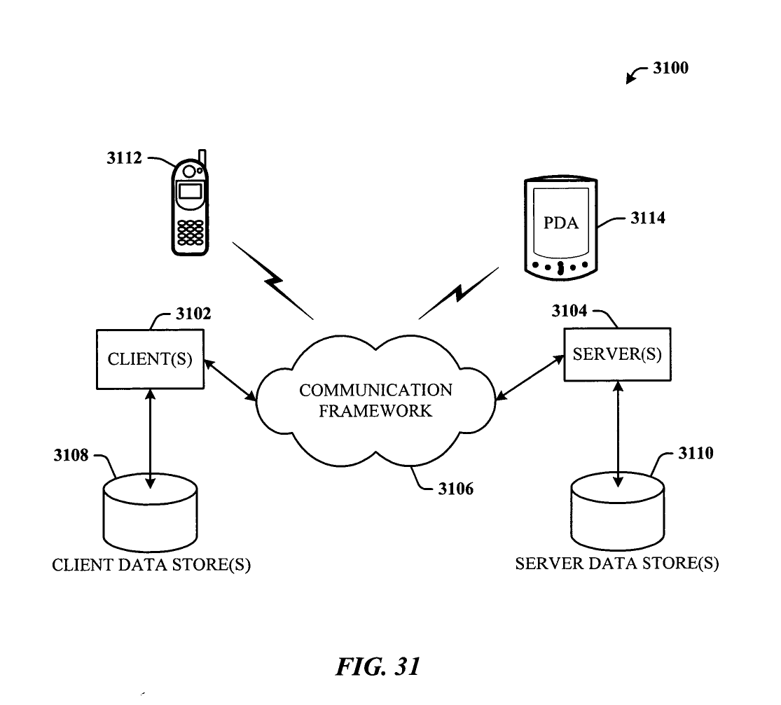

Referring now to FIG. 31, there is illustrated a schematic block diagram of an exemplary computing environment 3100 in accordance with the subject invention. The system 3100 includes one or more client(s) 3102. The client(s) 3102 can be hardware and/or software (e.g., threads, processes, computing devices). The client(s) 3102 can house cookie(s) and/or associated contextual information by employing the invention, for example.

The system 3100 also includes one or more server(s) 3104. The server(s) 3104 can also be hardware and/or software (e.g., threads, processes, computing devices). The servers 3104 can house threads to perform transformations by employing the invention, for example. One possible communication between a client 3102 and a server 3104 can be in the form of a data packet adapted to be transmitted between two or more computer processes. The data packet may include a cookie and/or associated contextual information, for example. The system 3100 includes a communication framework 3106 (e.g., a global communication network such as the Internet) that can be employed to facilitate communications between the client(s) 3102 and the server(s) 3104.

Communications can be facilitated via a wired (including optical fiber) and/or wireless technology. The client(s) 3102 are operatively connected to one or more client data store(s) 3108 that can be employed to store information local to the client(s) 3102 (e.g., cookie(s) and/or associated contextual information). Similarly, the server(s) 3104 are operatively connected to one or more server data store(s) 3110 that can be employed to store information local to the servers 3104. Devices such as a cellular telephone 3112 and a PDA 3114 can connect and/or participate in a call conferencing session.

Note that the architecture of the subject invention is not limited to call (or voice) conferencing, but also includes the capability of vide conferencing such that images are transmitted and present to participants during the session.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates hospitality teleconferencing services, comprising:
a hospitality communications component of a hospitality provider that facilitates hospitality communications for a user; and
a web-supported teleconferencing component that interfaces to the hospitality communications network to provide the hospitality communications services to the user.

2. The system of claim 1, wherein the web-supported teleconferencing component communicates with the hospitality communications component via at least one of a packet-switched network and a circuit-switched network.

3. The system of claim 1, wherein web-supported teleconferencing component facilitates communications to at least one of wired and wireless telephone communications systems.

4. The system of claim 1, wherein the web-supported teleconferencing component communicates hospitality services information to a group of users via a single PIN.

5. The system of claim 1, wherein the web-supported teleconferencing component facilitates one-way and two-way communications.

6. The system of claim 1, further comprising an artificial intelligence component that employs a probabilistic and/or statistical-based analysis to prognose or infer an action that the user desires to be automatically performed.

7. The system of claim 1, wherein the web-supported teleconferencing component dynamically binds two or more callers into a conference call session in response to processing a special code received from the hospitality provider.

8. The system of claim 1, wherein the hospitality communications component communicates a guest code and a hospitality provider code to the web-supported teleconferencing component in order to gain access to a conference call session.

9. The system of claim 8, wherein the guest code is a hospitality provider room number and the hospitality provider code is a unique PIN assigned to the hospitality provider.

10. The system of claim 1, wherein the web-supported teleconferencing component tracks call session data and communicates the call session data to a provider back-office system such that the user, who is a guest, can be invoiced at check-out time.

11. The system of claim 1, wherein a user message stored on the web-supported teleconferencing component is accessed and retrieved for presentation to the user, who is a guest of the hospitality provider.

12. The system of claim 1, wherein the web-supported teleconferencing component further comprises a dynamic port allocation device that dynamically binds a guest caller to a conference call session in response to receiving a special provider code.

13. The system of claim 1, wherein the web-supported teleconferencing component facilitates multimedia communications to a session participant during the session.

14. The system of claim 1, wherein the web-supported teleconferencing component facilitates operator assistance on a same voice channel as the user in response to entering an assistance code.

15. A method of providing call management services for a hospitality provider, comprising:
programming a hospitality provider telephone system to automatically dial an access number in response to receiving an access code;
communicating a hospitality provider code to an Internet-based call management system in response to a guest selecting the access code for a guest call;
binding the guest call into a call session via the Internet-based call management system;
tracking call session data of the call session; and
invoicing the guest at check-out time based on the call session data.

16. The method of claim 15, further comprising an act of communicating a guest room number along with the hospitality provider code, which hospitality provider code is a provider PIN that uniquely associates the guest call with the hospitality provider.

17. The method of claim 15, further comprising an act of offering a calling card to the guest at check-out time, the calling card includes a PIN and a toll-free number that provides access to the Internet-based call management system such that the user utilizes call conferencing services of the Internet-based call management system after checkout from the hospitality provider.

18. The method of claim 15, further comprising an act of initiating calling of a list of session participants by the Internet-based call management system, and binding the called session participants into the call session.

19. The method of claim 15, further comprising an act of billing the hospitality provider for the guest call via the Internet-based call management system, which guest call forms a conference call.

20. A system that facilitates conference call management services for a hospitality provider, comprising:
means for programming a hospitality provider telephone system to automatically dial an access number in response to receiving an access code;
means for communicating a hospitality provider code to an Internet-based call management system in response to a guest selecting the access code for a guest call;
means for binding the guest call into a call session via the Internet-based call management system;
means for tracking call session data of the call session; and
means for invoicing the guest at check-out time based on the call session data.
